(19) United States
(12) Patent Application Publication
(10) Pub. No.: US 2019/0356019 A1
(43) Pub. Date: Nov. 21, 2019

(54) SOLID ELECTROLYTE-CONTAINING SHEET, SOLID ELECTROLYTE COMPOSITION, ALL-SOLID STATE SECONDARY BATTERY, AND METHODS FOR MANUFACTURING SOLID ELECTROLYTE-CONTAINING SHEET AND ALL-SOLID STATE SECONDARY BATTERY

(71) Applicant: FUJIFILM Corporation, Tokyo (JP)

(72) Inventors: Tomonori MIMURA, Ashigarakami-gun (JP); Hiroaki MOCHIZUKI, Ashigarakami-gun (JP); Masaomi MAKINO, Ashigarakami-gun (JP)

(73) Assignee: FUJIFILM Corporation, Tokyo (JP)

(21) Appl. No.: 16/531,234

(22) Filed: Aug. 5, 2019

Related U.S. Application Data
(63) Continuation of application No. PCT/JP2018/007899, filed on Mar. 1, 2018.

(30) Foreign Application Priority Data
Mar. 8, 2017 (JP) 2017-044428

(51) Int. Cl. H01M 10/0562; H01M 10/0525

(52) U.S. Cl. CPC H01M 10/0562; H01M 2300/0071; H01M 2300/0094; H01M 10/0525

(57) ABSTRACT

Provided are a solid electrolyte-containing sheet containing an inorganic solid electrolyte (A) having a conductivity of an ion of a metal belonging to Group I or II of the periodic table and an inorganic compound (C) having a film on a surface, in which the film contains a solid electrolyte (B) and has a conductivity of an ion of a metal belonging to Group I or II of the periodic table, a solid electrolyte composition, an all-solid state secondary battery, and methods for manufacturing a solid electrolyte-containing sheet and an all-solid state secondary battery.

### CROSS-REFERENCE TO RELATED APPLICATIONS

This application is a Continuation of PCT International Application No. PCT/JP2018/007899 filed on Mar. 1, 2018, which claims priority under 35 U.S.C. § 119 (a) to Japanese Patent Application No. 2017-044428 filed in Japan on Mar. 8, 2017. Each of the above applications is hereby expressly incorporated by reference, in its entirety, into the present application.

### BACKGROUND OF THE PRESENT INVENTION

### 1. Field of the Present Invention

The present invention relates to a solid electrolyte-containing sheet, a solid electrolyte composition, an all-solid state secondary battery, and methods for manufacturing a solid electrolyte-containing sheet and an all-solid state secondary battery.

### 2. Description of the Related Art

A lithium ion secondary battery is a storage battery which has a negative electrode, a positive electrode, and an electrolyte interposed between the negative electrode and the positive electrode and enables charging and discharging by the reciprocal migration of lithium ions between both electrodes. In the related art, an organic electrolytic solution has been used as the electrolyte in lithium ion secondary batteries. However, organic electrolytic solutions are likely to cause liquid leakage, have a concern of the occurrence of a short circuit and ignition in batteries due to overcharging or overdischarging, and are demanded to further improve in terms of safety and reliability.

Under the above-described circumstances, all-solid state secondary batteries in which an inorganic solid electrolyte is used instead of the organic electrolytic solution are attracting attention. In all-solid state secondary batteries, all of the negative electrode, the electrolyte, and the positive electrode are solid, safety and reliability which are considered as a problem of batteries in which the organic electrolytic solution is used can be significantly improved, and it also becomes possible to extend service lives. Furthermore, all-solid state secondary batteries can be provided with a structure in which the electrodes and the electrolyte are directly disposed in series. Therefore, it becomes possible to increase the density of energy to be higher than those of secondary batteries in which the organic electrolytic solution is used, and the application to electric vehicles, large-sized storage batteries, and the like is anticipated.

Due to the respective advantages described above, active research and development is underway to put all-solid state secondary batteries into practical use as next-generation lithium ion batteries, and a number of techniques for improving the battery performance of all-solid state secondary batteries have been reported. In addition, techniques for preventing short circuits also have been reported. For example, JP2011-081915A discloses that it is possible to provide an all-solid state secondary battery in which a solid electrolyte layer containing two solid electrolytes having mutually different hardness is provided, thereby suppressing the occurrence of short circuits using a restraining pressure or the like.

### SUMMARY OF THE PRESENT INVENTION

The all-solid state secondary battery described in JP2011-081915A is considered to exhibit an effect for suppressing short circuits caused by pressurization during manufacturing and/or in the initial phase of use to a certain extent. However, the solid electrolyte layer disclosed in JP2011-081915A simply contains two solid electrolytes having mutually different hardness in a simply mixed state. Therefore, pores are generated due to active materials being expanded and contracted as the all-solid state secondary battery is continuously used, and thus a concern of the occurrence of short circuits increases.

An object of the present invention is to provide a solid electrolyte-containing sheet that is used in all-solid state secondary batteries and is capable of suppressing initial short circuits and aging short circuits in all-solid state secondary batteries. In addition, another object of the present invention is to provide a solid electrolyte composition that is used in all-solid state secondary batteries and is capable of suppressing the occurrence of initial short circuits and aging short circuits in all-solid state secondary batteries. In addition, still another object of the present invention is to provide an all-solid state secondary battery in which the solid electrolyte-containing sheet or the solid electrolyte composition is used. Furthermore, far still another object of the present invention is to provide methods for manufacturing the solid electrolyte-containing sheet and the all-solid state secondary battery.

The “Initial short circuit” refers to a short circuit that is caused by pressurization (for example, at 600 MPa or more) during the manufacturing of an all-solid state secondary battery. In addition, the “aging short circuit” refers to a short circuit that occurs in an aging-dependent manner after the use of the all-solid state secondary battery begins.

As a result of intensive studies, the present inventors found that an all-solid state secondary battery manufactured using a solid electrolyte-containing sheet which contains an inorganic solid electrolyte having a conductivity of an ion of a metal belonging to Group I or II of the periodic table and an inorganic compound (C) having a film on a surface and in which the film contains a solid electrolyte (B) and has a conductivity of an ion of a metal belonging to Group I or II of the periodic table is capable of suppressing the occurrence of initial short circuits and aging short circuits. The present invention was completed by repeating additional studies on the basis of the above-described finding.

As a result of a variety of studies by the present inventors, the above-described objects were achieved by the following means.

<1> A solid electrolyte-containing sheet comprising: an inorganic solid electrolyte (A) having a conductivity of an ion of a metal belonging to Group I or II of the periodic table; and an inorganic compound (C) having a film on a surface,

in which the film contains a solid electrolyte (B) and has a conductivity of an ion of a metal belonging to Group I or II of the periodic table.

<2> The solid electrolyte-containing sheet according to <1>, in which the inorganic solid electrolyte (A) and the solid electrolyte (B) are a sulfide-based inorganic solid electrolyte.

<3> The solid electrolyte-containing sheet according to <1> or <2>, in which the inorganic solid electrolyte (A) and the solid electrolyte (B) are compounds represented by Formula (1).

Lₐ₁M_{b1}P_{c1}S_{d1}Aₑ₁ Formula (1)

In the formula, L represents an element selected from Li, Na, and K. M represents an element selected from B, Zn, Sn, Si, Cu, Ga, Sb, Al, and Ge. A represents an element selected from I, Br, Cl, and F. al to el represent compositional ratios of the respective elements, and a1:b1:c1:d1:el satisfies 1 to 12:0 to 5:1:2 to 12:0 to 10.

<4> The solid electrolyte-containing sheet according to any one of <1> to <3>, in which the inorganic compound (C) is a compound represented by any of Formulae (c-1) to (c-13).

LiₓₐLa_{ya}TiO₃ Formula (c-1)

In the formula, xa and ya represent compositional ratios, xa satisfies 0.3≤xa≤0.7, and ya satisfies 0.3≤ya≤0.7.

Li_{xb}La_{yb}Zr_{zb}M^{bb}_{mb}O_{nb} Formula (c-2)

In the formula, M^{bb} represents Al, Mg, Ca, Sr, V, Nb, Ta, Ti, Ge, In, Sn, or a combination of two or more elements selected from Al, Mg, Ca, Sr, V, Nb, Ta, Ti, Ge, In, and Sn. xb, yb, zb, mb, and nb represent compositional ratios, xb satisfies 5≤x≤xb≤10, yb satisfies 1≤yb≤4, zb satisfies 1≤zb≤4, mb satisfies 0≤mb≤2, and nb satisfies 5≤nb≤20.

Li_{3.5}Zn_{0.25}GeO₄ Formula (c-3)

LiTi₂P₃O₁₂ Formula (c-4)

Li_{1+xh+yh}(Al, Ga),ₓₕ(Ti, Ge)₂₋ₓₕSi_{yh}P_{3-yh}O₁₂ Formula (c-5)

In the formula, xh satisfies 0≤xh≤1, and yh satisfies 0≤yh≤1.

Li₃PO₄ Formula (c-6)

LiPON Formula (c-7)

LiPOD Formula (c-8)

In the formula, D¹ represents Ti, V, Cr, Mn, Fe, Co, Ni, Cu, Zr, Nb, Mo, Ru, Ag, Ta, W, Pt, Au, or a combination of two or more elements selected from Ti, V, Cr, Mn, Fe, Co, Ni, Cu, Zr, Nb, Mo, Ru, Ag, Ta, W, Pt, and Au.

LiA¹ON Formula (c-9)

In the formula, A¹ represents Si, B, Ge, Al, C, Ga, or a combination of two or more elements selected from Si, B, Ge, Al, C, and Ga.

Li_{xc}B_{yc}M^{cc}_{zc}O_{nc} Formula (c-10)

In the formula, M^{cc} represents C, S, Al, Si, Ga, Ge, In, Sn, or a combination of two or more elements selected from C, S, Al, Si, Ga, Ge, In, and Sn. xc, yc, zc, and nc represent compositional ratios, xc satisfies 0≤xc≤5, yc satisfies 0<yc≤1, zc satisfies 0<zc≤1, and nc satisfies 0<nc≤6.

Li₍₃₋₂ₓₑ₎M^{ee}ₓₑD^{ee}O Formula (c-11)

In the formula, xe represents a numeric value of 0 or more and 0.1 or less, and M^{ee} represents a divalent metal atom. D^{ee} represents a halogen atom or a combination of two or more halogen atoms.

Li_{xf}Si_{yf}O_{zf} Formula (c-12)

In the formula, xf, yf, and zf represent compositional ratios, xf satisfies 1≤xf≤5, yf satisfies 0<yf≤3, and zf satisfies 1<zf≤10.

Li_{xg}S_{yg}O_{zg} Formula (c-13)

In the formula, xg, yg, and zg represent compositional ratios, xg satisfies 1≤xg≤3, yg satisfies 0<yg≤2, and zg satisfies 1≤zg≤10.

<5> The solid electrolyte-containing sheet according to any one of <1> to <4>, in which the inorganic compound (C) has at least one functional group of functional groups belonging to the following group of functional groups (I).

<Group of Functional Groups (I)>

A carboxy group, a sulfo group, a phosphoric acid group, a phosphonic acid group, a hydroxy group, a sulfanyl group, an isocyanate group, an oxetanyl group, an epoxy group, a dicarboxylic anhydride group, a carboxylic halide group, a silyl group, and an amino group

<6> The solid electrolyte-containing sheet according to any one of <1> to <5>, in which the inorganic compound (C) has at least one functional group of functional groups belonging to the following group of functional groups (II).

<Group of Functional Groups (II)>

A carboxy group, a sulfo group, a phosphoric acid group, a phosphonic acid group, a hydroxy group, an epoxy group, and an amino group

<7> The solid electrolyte-containing sheet according to any one of <1> to <6>, in which the inorganic compound (C) is surface-treated.

<8> The solid electrolyte-containing sheet according to any one of <1> to <7>, further comprising: a binder (D).

<9> The solid electrolyte-containing sheet according to <8>, in which the binder (D) is an acrylic resin and/or a polyurethane resin.

<10> The solid electrolyte-containing sheet according to any one of <1> to <9>, further comprising: an active material (E).

<11> A solid electrolyte composition comprising: an inorganic solid electrolyte (A) having a conductivity of an ion of a metal belonging to Group I or II of the periodic table; an inorganic compound (C) having a film on a surface; and a dispersion medium (F), in which the film contains a solid electrolyte (B) and has a conductivity of an ion of a metal belonging to Group I or II of the periodic table.

<12> The solid electrolyte composition according to <11>, in which the inorganic compound (C) has at least one functional group of functional groups belonging to the following group of functional groups (I).

<Group of Functional Groups (I)>

A carboxy group, a sulfo group, a phosphoric acid group, a phosphonic acid group, a hydroxy group, a sulfanyl group, an isocyanate group, an oxetanyl group, an epoxy group, a dicarboxylic anhydride group, a carboxylic halide group, a silyl group, and an amino group

<13> The solid electrolyte composition according to <11> or <12>, further comprising: a binder (D).

<14> An all-solid state secondary battery comprising: a positive electrode active material layer; a negative electrode active material layer; and a solid electrolyte layer, in which at least any one of the positive electrode active material layer, the negative electrode active material layer, or the solid electrolyte layer is the solid electrolyte-containing sheet according to any one of <1> to <10>.

<15> A method for manufacturing the solid electrolyte-containing sheet according to any one of <1> to <10>, the method comprising: a step of applying the solid electrolyte composition according to any one of <11> to <13> onto a base material; and a step of drying the applied solid electrolyte composition.

<16> A method for manufacturing an all-solid state secondary battery, wherein an all-solid state secondary battery is manufactured through the manufacturing method according to <15>.

In the description of the present invention, numerical ranges expressed using “to” include numerical values before and after “to” as the lower limit value and the upper limit value.

The solid electrolyte-containing sheet of the present invention is capable of suppressing initial short circuits and aging short circuits in all-solid state secondary batteries by being used in the all-solid state secondary batteries. In addition, the solid electrolyte composition of the present invention is capable of suppressing the occurrence of initial short circuits and aging short circuits in all-solid state secondary batteries by being used in the all-solid state secondary batteries. In addition, in the all-solid state secondary battery of the present invention, initial short circuits and aging short circuits do not easily occur. Furthermore, the method for manufacturing a solid electrolyte-containing sheet and the method for manufacturing an all-solid state secondary battery of the present invention are capable of manufacturing a solid electrolyte-containing sheet and an all-solid state secondary battery which have the above-described excellent performance.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating a coin-type jig produced in examples.

FIG. 3 is a vertical cross-sectional view schematically illustrating an electrode sheet for an all-solid state secondary battery produced in examples.

### DESCRIPTION OF THE PREFERRED EMBODIMENTS

### Preferred Embodiment

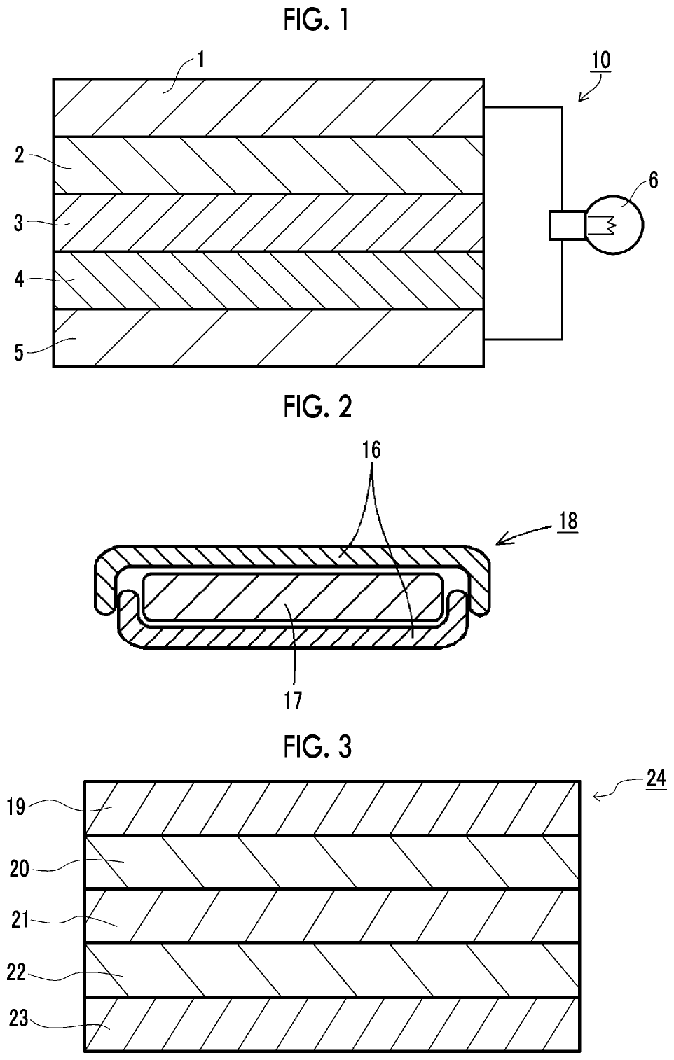

FIG. 1 is a cross-sectional view schematically illustrating an all-solid state secondary battery (lithium ion secondary battery) according to a preferred embodiment of the present invention. In the case of being seen from the negative electrode side, an all-solid state secondary battery 10 of the present embodiment has a negative electrode collector 1, a negative electrode active material layer 2, a solid electrolyte layer 3, a positive electrode active material layer 4, and a positive electrode collector 5 in this order. The respective layers are in contact with each other and have a laminated structure. In a case in which the above-described structure is employed, during charging, electrons (e) are supplied to the negative electrode side, and lithium ions (Li⁺) are accumulated on the negative electrode side. On the other hand, during discharging, the lithium ions (Li⁺) accumulated on the negative electrode side return to the positive electrode, and electrons are supplied to an operation portion 6. In an example illustrated in the drawing, an electric bulb is employed as the operation portion 6 and is lit by discharging.

A solid electrolyte-containing sheet of an embodiment of the present invention is preferred as the negative electrode active material layer, the solid electrolyte layer, and/or the positive electrode active material layer. In addition, a solid electrolyte composition of an embodiment of the present invention can be preferably used as a material used to shape the negative electrode active material layer, the solid electrolyte layer, and/or the positive electrode active material layer.

In the present specification, the positive electrode active material layer (hereinafter, also referred to as the positive electrode layer) and the negative electrode active material layer (hereinafter, also referred to as the negative electrode layer) will be collectively referred to as the electrode layer or the active material layer in some cases.

The thicknesses of the positive electrode active material layer 4, the solid electrolyte layer 3, and the negative electrode active material layer 2 are not particularly limited. Meanwhile, in a case in which the dimensions of ordinary batteries are taken into account, the thicknesses are preferably 10 to 1,000 μm and more preferably 20 μm or more and less than 500 μm. In the all-solid state secondary battery of the embodiment of the present invention, the thickness of at least one layer of the positive electrode active material layer 4, the solid electrolyte layer 3, or the negative electrode active material layer 2 is still more preferably 50 μm or more and less than 500 μm.

<Solid Electrolyte-Containing Sheet>

The solid electrolyte-containing sheet of the embodiment of the present invention contains an inorganic solid electrolyte (A) having a conductivity of an ion of a metal belonging to Group I or II of the periodic table and an inorganic compound (C) having a film on a surface, and the film contains a solid electrolyte (B) and has a conductivity of an ion of a metal belonging to Group I or II of the periodic table.

Hereinafter, the inorganic solid electrolyte (A) having a conductivity of an ion of a metal belonging to Group I or II of the periodic table will be simply referred to as the inorganic solid electrolyte (A) in some cases. The film containing the solid electrolyte (B) and having a conductivity of an ion of a metal belonging to Group I or II of the periodic table will be referred to as “the film in the present invention” in some cases. The inorganic compound (C) having the above-described film on a surface will be referred to as the coated inorganic compound (C) in some cases.

In addition, there will be cases in which the respective components that are included in the solid electrolyte-containing sheet are described with no references presented thereto. That is, for example, there will be cases in which the inorganic solid electrolyte (A) is simply referred to as the inorganic solid electrolyte. What has been described above is also true for components that are included in the solid electrolyte composition described below.

The respective components that are included in the solid electrolyte-containing sheet and the solid electrolyte composition of the embodiment of the present invention may be used singly or two or more may be used in combination.

(Inorganic Solid Electrolyte (A))

The inorganic solid electrolyte is a solid electrolyte that is inorganic, and the solid electrolyte refers to a solid-form electrolyte capable of migrating ions therein. The inorganic solid electrolyte is clearly differentiated from organic solid electrolytes (polymer electrolytes represented by polyethylene oxide (PEO) or the like and organic electrolyte salts represented by lithium bis(trifluoromethanesulfonyl)imide (LiTFSI)) since the inorganic solid electrolyte does not include any organic substances as a principal ion-conductive material. In addition, the inorganic solid electrolyte is solid in a static state and is thus, generally, not disassociated or liberated into cations and anions. Due to this fact, the inorganic solid electrolyte is also clearly differentiated from inorganic electrolyte salts of which cations and anions are disassociated or liberated in electrolytic solutions or polymers (LiPF₆, LiBF₄, LiFSI, LiCl, and the like). The inorganic solid electrolyte is not particularly limited as long as the inorganic solid electrolyte has a conductivity of an ion of a metal belonging to Group I or II of the periodic table and is generally a substance not having an electron conductivity.

In the present invention, the inorganic solid electrolyte has a conductivity of an ion of a metal belonging to Group I or II of the periodic table. As the inorganic solid electrolyte, it is possible to appropriately select and use a solid electrolyte material that is applied to this kind of products. Typical examples of the inorganic solid electrolyte include (i) a sulfide-based inorganic solid electrolyte and (ii) an oxide-based inorganic solid electrolyte. In the present invention, the sulfide-based inorganic solid electrolyte is preferably used since it is possible to form a more favorable interface between an active material and the inorganic solid electrolyte.

(i) Sulfide-Based Inorganic Solid Electrolyte

The sulfide-based inorganic solid electrolyte is preferably a compound which contains a sulfur atom (S), has an ion conductivity of a metal belonging to Group I or II of the periodic table, and has an electron-insulating property. The sulfide-based inorganic solid electrolyte is preferably an inorganic solid electrolyte which, as elements, contains at least Li, S, or P and has a lithium ion conductivity, but the sulfide-based inorganic solid electrolyte may also include elements other than Li, S, and P depending on the purposes or cases.

The solid electrolyte-containing sheet of the embodiment of the present invention preferably contains, as the sulfide-based inorganic solid electrolyte, a lithium ion-conductive inorganic solid electrolyte satisfying Formula (1) since the ion conductivity is more favorable.

Lₐ₁M_{b1}P_{c1}S_{d1}Aₑ₁ Formula (1)

In the formula, L represents an element selected from Li, Na, and K and is preferably Li. M represents an element selected from B, Zn, Sn, Si, Cu, Ga, Sb, Al, and Ge. A represents an element selected from I, Br, Cl, and F. al to el represent compositional ratios of the respective elements, and a1:b1:c1:d1:e1 satisfies 1 to 12:0 to 5:1:2 to 12:0 to 10. Furthermore, a1 is preferably 1 to 9 and more preferably 1.5 to 7.5. b1 is preferably 0 to 3 and more preferably 0 to 1. Furthermore, dl is preferably 2.5 to 10 and more preferably 3.0 to 8.5. Furthermore, e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolyte may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolyte can be manufactured by a reaction of at least two raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio between Li₂S and P₂S₅ in the Li—P—S-based glass and the Li—P—S-based glass ceramic is preferably 60:40 to 90:10 and more preferably 68:32 to 78:22 in terms of the molar ratio between Li₂S:P₂S₅. In a case in which the ratio between Li₂S and P₂S₅ is set in the above-described range, it is possible to increase the lithium ion conductivity. Specifically, the lithium ion conductivity can be preferably set to 1×10⁻⁴ S/cm or more and more preferably set to 1×10⁻³ S/cm or more. The upper limit is not particularly limited, but practically 100 S/cm or less.

As specific examples of the sulfide-based inorganic solid electrolyte, combination examples of raw materials will be described below. Examples thereof include Li₂S—P₂S₅, Li₂S—P₂S₅—LiCl, Li₂S—P2S₅—H₂S, Li₂S—P₂S₅—H₂S—LiCl, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S5—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅LiI, Li₂S—SiS₂—LiI, L₂S SiS₂—Li₄SiO₄, Li₂S—SiS2—Li₃PO₄, Li₁₀GeP₂S₁₂, and the like. Here, the mixing ratios between the respective raw materials do not matter. Examples of a method for synthesizing the sulfide-based inorganic solid electrolyte material using the above-described raw material compositions include an amorphorization method. Examples of the amorphorization method include a mechanical milling method, a solution method, and a melting quenching method. This is because these treatments are possible at normal temperature and manufacturing steps can be simplified.

(ii) Oxide-Based Inorganic Solid Electrolyte

The oxide-based inorganic solid electrolyte is preferably a compound which contains an oxygen atom (O), has an ion conductivity of a metal belonging to Group I or II of the periodic table, and has an electron-insulating property.

As specific compound examples, for example,
Formula (c-1): LiₓₐLa_{ya}TiO₃[xa and ya represent compositional ratios, xa=0.3 to 0.7, and ya=0.3 to 0.7] (LLT),
Formula (c-2): Li_{xb}La_{yb}Zr_{zb}M^{bb}_{mb}O_{nb} (M^{bb} Al, Mg, Ca, Sr, V, Nb, Ta, Ti, Ge, In, Sn, or a combination of two or more elements selected from Al, Mg, Ca, Sr, V, Nb, Ta, Ti, Ge, In, and Sn, xb, yb, zb, mb, and nb represent compositional ratios, xb satisfies 5≤xb≤10, yb satisfies 1≤yb≤4, satisfies 1≤zb≤4, mb satisfies 0≤mb≤2, and nb satisfies 5≤nb≤20.),
Formula (c-3): Li_{3.5}Zn_{0.25}GeO₄,
Formula (c-4): LiTi₂P₃O₁₂,
Formula (c-5): Li_{1+xh+yh}(Al, Ga)_{xb}(Ti, Ge)₂₋ₓₕSi_{yh}P_{3-yh}O₁₂ (here, xh satisfies 0≤xh≤1, and yh satisfies 0≤yh≤1.), and the like are exemplified.

In addition, a phosphorus compound containing Li, P and O is also desirable. For example,
Formula (c-6): lithium phosphate (Li₃PO₄),
Formula (c-7): LiPON obtained by substituting some of oxygen in lithium phosphate with nitrogen,
Formula (c-8): LiPOD¹ (D¹ represents Ti, V, Cr, Mn, Fe, Co, Ni, Cu, Zr, Nb, Mo, Ru, Ag, Ta, W, Pt, Au, or a combination of two or more elements selected from C, S, Al, Si, Ga, Ge, in, and Sn.), and the like are exemplified.

In addition,
Formula (c-9): LiA¹ON (A¹ represents Si, B, Ge, Al, C, Ga, or a combination of two or more elements selected from Si, B, Ge, Al, C, and Ga.),
Formula (c-10): Li_{xc}B_{yc}M^{cc}_{zc}O_{nc} (M^{cc} represents C, S, Al, Si, Ga, Ge, In, Sn, or a combination of two or more elements selected from C, S, Al, Si, Ga, Ge, In, and Sn, xc, yc, zc, and nc represent compositional ratios, xc satisfies 0≤xc≤5, yc satisfies 0<yc≤1, zc satisfies 0<zc≤1, and nc satisfies 0<nc≤6.), Li_{xd}(Al, Ga)_{yd}(Ti, _{Ge})_{zd}Si_{ad}P_{md}O_{nd} (here, 1≤xd≤3, 0≤yd≤1, 0≤zd≤2, 0≤ad≤1, 1≤md≤7, and 3≤nd≤13),
Formula (c-11): Li₍₃₋₂ₓₑ₎M^{ee}ₓₑD^{ee}O (xe represents a numeric value of 0 or more and 0.1 or less, and M^{ee} represents a divalent metal atom. D^{ee} represents a halogen atom or a combination of two or more halogen atoms.),
Formula (c-12): Li_{xf}Si_{yf}O_{zf} (xf, yf, and zf represent compositional ratios, xf satisfies 1≤xf≤5, yf satisfies 0≤yf≤3, and zf satisfies 1≤zf≤10.),
Formula (c-13): Li_{xg}S_{yg}O_{zg} (xg, yg, and zg represent compositional ratios, xg satisfies 1≤xg≤3, yg satisfies 0<yg≤2, and zg satisfies 1≤zg≤10.), and the like can also be preferably used.

Meanwhile, LLZ is one form of the compound represented by Formula (c-2).

The volume-average particle diameter of the inorganic solid electrolyte is not particularly limited, but is preferably 0.01 ∞m or more and more preferably 0.1 μm or more. The upper limit is preferably 100 μm or less and more preferably 50 μm or less. Meanwhile, the average particle diameter of inorganic solid electrolyte particles is measured in the following order. A 1% by mass dispersion liquid of the inorganic solid electrolyte particles is diluted and adjusted using water (heptane in a case in which the inorganic solid electrolyte particles are unstable in water) in a 20 ml sample bottle. The diluted dispersed specimen is irradiated with 1 kHz ultrasonic waves for 10 minutes and then immediately used for testing. Data are captured 50 times using this dispersion liquid specimen, a laser diffraction/scattering-type particle size distribution measurement instrument LA-920 (trade name, manufactured by Horiba Ltd.), and a silica cell for measurement at a temperature of 25° C., thereby obtaining the volume-average particle diameter. Regarding other detailed conditions and the like, the description of 11s Z8828:2013 “Particle size analysis-Dynamic light scattering method” is referred to as necessary. Five specimens are produced per level, and the average value thereof is employed.

(Inorganic Compound (C))

The inorganic compound (C) is not particularly limited as long as the inorganic compound is generally used as an active material in all-solid state secondary batteries, and examples thereof include metal single bodies (for example, elements of Group I to XIV of the periodic table; specific examples thereof include silver, copper, titanium, and tin), oxides (oxides of elements of Group I to XIV of the periodic table; specific examples thereof include alumina, silica, zirconia, titania, copper oxide, iron oxide, silver oxide, cobalt oxide, zinc oxide, and lithium oxide. In addition, the oxide-based inorganic solid electrolyte is also preferred.), nitrides (for example, nitrides of elements of Groups I to XIV of the periodic table; specific examples thereof include boron nitride.), halides (for example, halides of elements of Groups I to XIV of the periodic table; specific examples thereof include sodium chloride, lithium chloride, magnesium chloride, and iron chloride.), hydroxides (for example, hydroxides of elements of Groups I to XIV of the periodic table; specific examples thereof include sodium hydroxide, calcium hydroxide, magnesium hydroxide, and lithium hydroxide.), carbonates (for example, carbonates of elements of Groups I to XIV of the periodic table; specific examples thereof include calcium carbonate and sodium carbonate.), sulfates (for example, sulfates of elements of Groups I to XIV of the periodic table; specific examples thereof include calcium sulfate and sodium sulfate.), silicates (for example, silicates of elements of Groups I to XIV; specific examples thereof include magnesium silicate.), carbides (for example, carbides of elements of Groups I to XIV of the periodic table; examples thereof include silicon carbide.) and the above-described sulfide-based inorganic solid electrolyte. Among these, oxides, hydroxides, carbonates, and nitrides are preferred, oxides are more preferred, and the sulfide-based inorganic solid electrolyte is particularly preferred.

As the inorganic compound (C), a compound represented by any of Formulae (C-1) to (C-13) is preferred, and a compound represented by any of Formulae (C-1) to (C-9) is more preferred since the compound has an ion conductivity of a metal belonging to Group I or II of the periodic table.

The shape of the inorganic compound (C) is not particularly limited, but is preferably particulate.

The volume-average particle diameter of the inorganic compound (C) is preferably 0.001 μm to 100 μm, more preferably 0.01 μm to 20 μm, particularly preferably 0.1 μm to 10 μm, and most preferably 1μm to 5 μm.

The volume-average particle diameter of the inorganic compound (C) having a film in the present invention on a surface is preferably 0.001 μm to 30 μm, more preferably 0.01 μm to 20 μm, particularly preferably 0.1 μm to 10 μm, and most preferably 1 μm to 5 μm.

Meanwhile, the volume-average particle diameters of the inorganic compound (C) having a film on a surface are identical to a method for measuring the volume-average particle diameter of the inorganic solid electrolyte (A).

The inorganic compound (C) is preferably harder than the inorganic solid electrolyte (A) in order to suppress short circuits during pressing. The indentation hardness is preferably 0.1 GPa or more, more preferably 0.2 GPa or more, and particularly preferably 0.5 GPa or more. The upper limit is not particularly limited, but is practically 300 GPa or less. The ratio of the indentation hardness of the inorganic compound (C) to the indentation hardness of the inorganic solid electrolyte (A) is preferably 1 or more, more preferably 2 or more, and particularly preferably 4 or more. The upper limit is not particularly limited, but is practically 100,000 or less. The indentation hardness can be evaluated using a micro compression tester (for example, MCT-W500 (trade name) manufactured by Shimadzu Corporation).

The inorganic compound (C) preferably does not transmit electrons, and the electron conductivity thereof is preferably 1×10⁻⁴ S/cm or less, more preferably 1×10⁻⁶ S/cm or less, and particularly preferably 1×10⁻⁹ S/cm or less.

The inorganic compound (C) preferably has an ion conductivity, more preferably has an ion conductivity of a metal belonging to Group I or II of the periodic table, and particularly preferably has a Li ion conductivity.

The ion conductivity at 30° C. of the inorganic compound (C) is preferably 1×10⁻⁶ S/cm or more, more preferably 1 ×10⁻⁵ S/cm or more, and particularly preferably 1×10⁻⁴ S/cm or more. The upper limit is not particularly limited, but is practically 100 S/cm or less.

The inorganic compound (C) that is used in the present invention preferably has at least one functional group of functional groups belonging to the following group of functional groups (I)

<Group of Functional Groups (I)>

A carboxy group, a sulfo group (sulfonic acid group), a phosphoric acid group, a phosphonic acid group, a hydroxy group, a sulfanyl (thiol) group, an isocyanato (isocyanate) group, an oxetanyl group, an epoxy group, a dicarboxylic anhydride group, a carboxylic halide group, a silyl group (—SiR₃, R represents a hydrocarbon group, and the number of carbon atoms in R is preferably 1 to 6. A plurality of R′s may be identical to or different from each other), and an amino group

In the case of having the above-described functional group, the inorganic compound (C) strongly interacts with the solid electrolyte (B) and is capable of further suppressing peeling at the interface between the solid electrolyte (B) and the inorganic compound (C).

The inorganic compound (C) that is used in the present invention more preferably has at least one functional group of functional groups belonging to the following group of functional groups (II) in order to more strongly interact with the solid electrolyte (B).

<Group of Functional Groups (II)>

A carboxy group, a sulfo group, a phosphoric acid group, a phosphonic acid group, a hydroxy group, an epoxy group, and an amino group

In the present invention, an inorganic compound having the above-described functional group in advance may also be used. In addition, in the case of introducing the above-described functional group to a surface of an inorganic compound not having the above-described functional group in advance, a method therefor is not particularly limited, and examples thereof include a method for treating the surface of the inorganic compound described below.

In a case in which a decrease in the interface resistance and the maintenance of the decreased interface resistance when used in an all-solid state secondary battery are taken into account, the content of the inorganic solid electrolyte (A) in the solid electrolyte-containing sheet of the embodiment of the present invention is preferably 1% by mass or more, more preferably 5% by mass or more, and particularly preferably 15% by mass or more with respect to 100% by mass of the solid components. From the same viewpoint, the upper limit is preferably 95% by mass or less, more preferably 90% by mass or less, and particularly preferably 85% by mass or less.

In a case in which the satisfaction of both the strength and ion conductivity of the sheet is taken into account, the content of the inorganic compound (C) having a film in the present invention in the solid electrolyte-containing sheet of the embodiment of the present invention is preferably 1% by mass or more, more preferably 5% by mass or more, and particularly preferably 10% by mass or more with respect to 100% by mass of the solid components. From the same viewpoint, the upper limit is preferably 50% by mass or less, more preferably 30% by mass or less, and particularly preferably 20% by mass or less.

The ratio of the content of the inorganic solid electrolyte (A) to the content of the inorganic compound (C) having a film in the present invention on a surface (the content of the inorganic solid electrolyte (A)/the content of the inorganic compound (C) having a film in the present invention on a surface) is not particularly limited, but is preferably 100/1 to 1/1, more preferably 20/1 to 4/1, and particularly preferably 10/1 to 5/1.

The solid content (solid component) in the present specification refers to a component that does not disappear by volatilization or evaporation in the case of being dried in a nitrogen atmosphere at 120° C. for six hours. Typically, the solid content refers to a component other than a dispersion medium described below.

(Solid Electrolyte (B))

The solid electrolyte (B) may be any of an inorganic solid electrolyte or an organic solid electrolyte. In the present invention, the solid electrolyte (B) is preferably an inorganic solid electrolyte in order to improve the ion conductivity. In a case in which the solid electrolyte (B) is an inorganic solid electrolyte, the film in the present invention is the inorganic solid electrolyte formed in a film shape. On the other hand, in a case in which the solid electrolyte (B) is an organic solid electrolyte, the film in the present invention is a mixture of the organic solid electrolyte and a salt of a metal belonging to Group I or II of the periodic table formed in a film shape.

As the inorganic solid electrolyte that is used as the solid electrolyte (B), the above-described inorganic solid electrolyte (A) can be employed. The solid electrolyte (B) may be a compound that is identical to or different from the inorganic solid electrolyte (A), and the inorganic solid electrolyte (A) and the solid electrolyte (B) are both preferably a sulfide-based inorganic solid electrolyte and more preferably a sulfide-based inorganic solid electrolyte represented by Formula (1) in order to improve the surface-forming property and the ion conductivity.

As the organic solid electrolyte that is used as the solid electrolyte (B), a solid polymer electrolyte (SPE) is not particularly limited, and examples thereof include polyethylene oxide (PEO), polyacrylonitrile (PAN), and polycarbonate (PC) which contain at least one supporting electrolyte.

In addition, as the salt of a metal belonging to Group I or II of the periodic table that constitutes the film in the present invention with the above-described inorganic solid electrolyte, for example, inorganic lithium salts, fluorine-containing organic lithium salts, oxalate borate salts, and the like are exemplified, lithium salts (inorganic lithium salts and fluorine-containing organic lithium salts) are preferred, and inorganic lithium salts are more preferred. As these salts, salts that are generally used in secondary batteries can be used without any particular limitation. For example, it is possible to use salts described in Paragraphs [0093] to [0096] of JP2015-046376A, the content of which is preferably incorporated into the present specification. Specifically, LiPF₆, LiClO₄, LiTFSI, LIFSI, LiBF₄, or the like is preferably used.

The content of the salt of a metal belonging to Group I or II of the periodic table is preferably 5 to 300 parts by mass and more preferably 20 to 100 parts by mass with respect to 100 parts by mass of the organic solid electrolyte.

—Method for Treating Surface of Inorganic Solid Electrolyte—

The inorganic compound that is used in the present invention may be surface-treated in order to introduce a functional group belonging to the group of functional groups (I) thereto.

A method for treating the surface of the inorganic compound is not particularly limited, and examples thereof include an active light ray exposure treatment, a firing treatment, surface coating using a sol-gel reaction, a surface treatment using a coupling agent, a surface treatment by surface graft polymerization, and polymer coating. Among these, an active light ray exposure treatment, a firing treatment, and a surface treatment using a coupling agent are preferred, and an active light ray exposure treatment and a firing treatment are particularly preferred.

—Method for Modifying Inorganic Compound by Active Light Ray Exposure Treatment—

The surface of the inorganic compound can be hydrophilized by exposing the surface of the inorganic compound to active light rays and adding a predetermined amount of an oxygen element thereto. That is, it is possible to introduce a hydroxy group, a carboxy group, a carbonyl group, an ester group, an ether group, a cyclic ether group, an aldehyde group, or the like to the surface of the inorganic compound.

As the active light rays in the present invention, infrared rays, microwaves, ultraviolet rays, excimer laser light, electron beams (EB), X-rays, high-energy light rays having a wavelength of 50 nm or shorter (EUV and the like), plasma, and the like are preferably exemplified. The active light ray is more preferably plasma and particularly preferably low-temperature atmospheric-pressure plasma.

In the present invention, plasma is preferably used since the degree of hydrophilization is higher not only on the surface of the inorganic compound irradiated with plasma but also in the inorganic compound than that on a surface not irradiated with plasma, and gas fills even the microstructure of the inorganic compound, whereby an effect for improving the bonding property with the film in the present invention is exhibited.

An atmosphere for exposing the inorganic compound to the active light rays is not particularly limited, may be a vacuum or the atmosphere, and may be a gas atmosphere other than the vacuum or the atmosphere. In order to oxidize the surface, oxygen is preferably present.

The exposure time is not particularly limited, but is preferably 1 second to 24 hours, more preferably 5 seconds to 2 hours, and particularly preferably 10 seconds to 30 minutes.

The surface of the inorganic compound can be treated in a state of an inorganic compound single body or a slurry obtained by dispersing the inorganic compound in a liquid.

For plasma irradiation, a variety of atmospheric-pressure devices can be used. For example, a device capable of generating low-temperature atmospheric-pressure plasma by carrying out intermittent discharge while causing an inert gas having a pressure near the atmospheric-pressure between electrodes covered with a dielectric body and the like are preferred.

Regarding the plasma device, a variety of modification examples can be selected depending on the intended use and the like. There are commercially available atmospheric-pressure plasma devices, and it is possible to preferably use, for example, ordinary atmospheric-pressure plasma devices such as ATMP-1000 manufactured by Arios Inc., an atmospheric-pressure plasma device manufactured by Haiden Laboratory, S5000-type atmospheric-pressure low-temperature plasma jet device and ASS-400-type, PPU-800-type, and SKIp-ZKB-type powder plasma devices manufactured by Sakigake-Semiconductor Co., Ltd., MyPL100 and ILP-1500 manufactured by Well inc., and RD550 manufactured by Sekisui Chemical Co., Ltd. (all trade names).

Meanwhile, in the present invention, the “pressure near the atmospheric-pressure” in the “low-temperature atmospheric-pressure plasma” refers to a range of 70 kPa or more and 130 kPa or less and is preferably a range of 90 kPa or more and 110 kPa or less.

As a discharge gas that is used during the generation of the atmospheric-pressure plasma, it is possible to use any gas of nitrogen, oxygen, hydrogen, argon (Ar), helium (He), ammonia, or carbon dioxide or a gas mixture of two or more gases thereof. A carbon dioxide gas or a nitrogen gas is preferably used.

For example, in the case of using a nitrogen gas, a functional group containing a nitrogen atom is introduced. Functional groups containing a nitrogen atom (amines, amides, nitro, urethanes (R¹OC(═O)NR²R³), imines (R⁴R⁵C═N—R⁶), enamines (R⁷R⁸C═CR⁹—NR¹⁰R¹¹), oximes (R¹²R¹³C═N—OR¹⁴), lactams (R¹⁵C(═O)NR¹⁶R¹⁷), R¹ to R¹⁷ are random organic groups, and these groups form covalent bonds with particles) are exemplified.

Meanwhile, the plasma treatment may be carried out in a batch mode or in an in-line mode by connecting other steps.

From the viewpoint of suppressing damage to the inorganic compound, it is effective to separate a plasma action portion and a discharge portion or to suppress the occurrence of the local concentration (streamer) of plasma with a sophisticated effort on the discharge circuit, thereby generating uniform plasma. In particular, the latter method is preferred since it is possible to carry out a uniform plasma treatment throughout a large area. As the former method, a method in which plasma generated by discharge is transported using an air stream of an inert gas is preferred, and, particularly, a so-called plasma jet method is preferred. In this case, a pathway (conduction tube) for transporting the inert gas including plasma is preferably a dielectric body such as glass, porcelain, or an organic polymer. As the latter method, a method in which glow plasma streamer of which is suppressed by conducting electricity between electrodes covered with a dielectric body through a pulse control element is generated, which is described in the specifications of WO2005/062338A and WO2007/024134A is preferred.

As the temperature during the plasma irradiation, a random temperature can be selected depending on the characteristics of the inorganic compound that is irradiated with plasma, but the temperature rise attributed to the irradiation with the low-temperature atmospheric-pressure plasma is preferably small since it is possible to alleviate damage. In a case in which a region to which the plasma applied is apart from a plasma generation device, the above-described effect further improves.

In the above-described method, in a case in which the low-temperature atmospheric-pressure plasma is selected and radiated, it is possible to decrease the amount of heat energy supplied from the plasma and to suppress the temperature rise. The temperature rise attributed to the plasma irradiation is preferably 50° C. or less, more preferably 40° C. or less, and particularly preferably 20° C. or less.

The temperature during the plasma irradiation is preferably equal to or lower than a temperature at which the inorganic compound (C) to be irradiated with plasma is capable of withstanding and, generally, is preferably −196° C. or higher and lower than 150° C. and more preferably −21° C. or higher and 100° C. or lower.

Furthermore, the temperature is preferably −10° C. or higher and 80° C. or lower and more preferably a temperature near room temperature (25° C.) that is present under the ambient temperature atmosphere. The low-temperature atmospheric-pressure plasma in the present invention refers to plasma that is radiated at 0° C. or higher and 50° C. or lower.

—Method for Modifying Surface of Inorganic Compound by Firing—

In the present invention, the surface of the inorganic compound can also be treated by firing.

A firing method is to expose the inorganic compound to a temperature of 200° C. or higher and 1,200° C. or lower, more preferably 300° C. or higher and 900° C. or lower, and particularly preferably a temperature of 350° C. or higher and 600° C. or lower. The atmosphere may be any of in the air, in a carbon dioxide atmosphere, or in an inert gas atmosphere (nitrogen, argon, or the like) and is preferably in the air or in a carbon dioxide atmosphere. In the case of firing the inorganic compound in an inert gas atmosphere, the inorganic compound is exposed in the air or in a carbon dioxide atmosphere for a certain period of time after firing. In such a case, it is possible to improve the hydrophilicity of the particle surfaces, that is, introduce a hydroxy group, a carboxy group, a carbonyl group, an ester group, an ether group, a cyclic ether group, an aldehyde group, or the like to the surface of the inorganic compound. The inorganic compound is most preferably fired in the presence of carbon dioxide. The firing time is 5 minutes to 24 hours, preferably 10 minutes to 10 hours, and most preferably 30 minutes to 2 hours. As a device for carrying out firing, a firing furnace can be used, and, regarding the kind of firing furnaces, an electric furnace, a gas furnace, a kerosene furnace, or the like can be used.

—Method for Covering Inorganic Compound (C) with Solid Electrolyte (B)—

A method for covering the inorganic compound (C) with the solid electrolyte (B), that is, a method for preparing the inorganic compound (C) having a film in the present invention on a surface is not particularly limited. For example, the inorganic compound (C) is injected into a solution obtained by dissolving the inorganic solid electrolyte (B) in an organic solvent and stirred at room temperature (20° C. to 30° C.) for 1 to 60 minutes. After that, the inorganic compound is dried at a reduced pressure and 80° C. to 150° C. for 0.5 to 5 hours, whereby the inorganic compound (C) can be covered with an inorganic solid electrolyte (B). In addition, the inorganic compound (C) is injected into a solution obtained by dissolving an organic solid electrolyte (B) and the salt of a metal belonging to Group I or II of the periodic table in an organic solvent and stirred at room temperature (20° C. to 30° C.) for 1 to 60 minutes. After that, the inorganic compound is dried at a reduced pressure and 80° C. to 150° C. for 0.5 to 5 hours, whereby the inorganic compound (C) can be covered with the organic solid electrolyte (B).

The solid electrolyte (B) may uniformly or unevenly coat all or part of the inorganic compound (C).

The organic solvent that dissolves the inorganic solid electrolyte (B) is preferably an alcohol compound solvent, an ether compound solvent, an amino compound solvent, a ketone compound solvent, a nitrile compound solvent, an ester compound solvent, or a carbonate compound solvent, more preferably an alcohol compound solvent, an amide compound solvent, or a carbonate compound solvent, and, among them, methanol, ethanol, propanol, N-methylformamide, N,N-dimethylformamide, dimethyl carbonate, diethyl carbonate, and ethyl methyl carbonate are preferred.

As other methods for covering the inorganic compound (C) with the inorganic solid electrolyte (B), a method in which a solution obtained by dissolving a raw material of the inorganic solid electrolyte (B) is used instead of the solution obtained by dissolving the inorganic solid electrolyte (B) in the above-described method, a blast method, an air sol deposition method, a cold spray method, a sputtering method, chemical vapor deposition (CVD), flame gunning, and a method in which a sol-gel reaction is used are exemplified.

An aspect in which the inorganic compound (C) is thermally treated after being covered with the inorganic solid electrolyte (B) is also preferred. The thermal treatment temperature is preferably 150° C. to 500° C., more preferably 200° C. to 400° C., and particularly preferably 250° C. to 350° C. Pressure reduction during the thermal treatment is preferably carried out in an inert gas atmosphere (for example, in an argon, helium, or nitrogen atmosphere).

(Binder (D))

The solid electrolyte-containing sheet of the embodiment of the present invention may contain a binder and may preferably contain a polymer particle. More preferably, the solid electrolyte composition may contain a polymer particle containing a macromonomer component.

The binder that is used in the present invention is not particularly limited as long as the binder is an organic polymer.

Binders that can be used in the present invention are not particularly limited, and, for example, binders consisting of a resin described below are preferred.

Examples of fluorine-containing resins include polytetrafluoroethylene (PTFE), polyvinylene difluoride (PVdF), and copolymers of polyvinylene difluoride and hexafluoropropylene (PVdF-HFP).

Examples of hydrocarbon-based thermoplastic resins include polyethylene, polypropylene, styrene butadiene rubber (SBR), hydrogenated styrene butadiene rubber (HSBR), butylene rubber, acrylonitrile butadiene rubber, polybutadiene, polyisoprene, polyisoprene latex, and the like.

Examples of acrylic resins include a variety of (meth)acrylic monomers, (meth)acrylic amide monomers, and copolymers of monomers constituting these resins (preferably copolymers of acrylic acid and methyl acrylate).

In addition, copolymers with other vinyl-based monomers are also preferably used. Examples thereof include copolymers of methyl (meth)acrylate and styrene, copolymers of methyl (meth)acrylate and acrylonitrile, and copolymers of butyl (meth)acrylate, acrylonitrile, and styrene. In the specification of the present application, a copolymer may be any one of a statistic copolymer, a periodic copolymer, a blocked copolymer, and a graft copolymer, and a blocked copolymer is preferred.

Examples of other resins include a polyurethane resin, a polyurea resin, a polyamide resin, a polyimide resin, a polyester resin, a polyether resin, a polycarbonate resin, a cellulose derivative resin, and the like.

Among these, the fluorine-containing resins, the hydrocarbon-based thermoplastic resins, the acrylic resins, the polyurethane resins, the polycarbonate resins, and the cellulose derivative resin are preferred, and acrylic resins and polyurethane resins are particularly preferred since the affinity to the inorganic solid electrolyte is favorable and the flexibility of the resins is favorable.

These binders may be used singly or two or more binders may be used in combination.

The shape of the binder is not particularly limited and may be a particle shape or an irregular shape in the all-solid state secondary battery and is preferably a particle shape.

Meanwhile, as the binder that is used in the present invention, a commercially available product can be used. In addition, the binder can also be prepared using an ordinary method.

The moisture concentration of the binder that is used in the present invention is preferably 100 ppm (mass-based) or less.

In addition, the binder that is used in the present invention may be used in a solid state and may be used in a polymer particle dispersion liquid or polymer solution state.

The mass-average molecular weight of the binder that is used in the present invention is preferably 5,000 or more, more preferably 10,000 or more, and still more preferably 30,000 or more. The upper limit is practically 1,000,000 or less, but an aspect in which a binder having a mass-average molecular weight in the above-described range is crosslinked is also preferred.

—Measurement of Molecular Weight—

Unless particularly otherwise described, the molecular weight of the binder in the present invention refers to the mass-average molecular weight, and the standard polystyrene-equivalent mass-average molecular weight is measured by means of gel permeation chromatography (GPC). Regarding a measurement method, a value measured using a method under the following conditions is used. Here, an appropriate eluent may be appropriately selected and used depending on the kind of the binder.

(Conditions)

Column: A column obtained by connecting TOSOH TSKgel Super HZM-H (trade name), TOSOH TSKgel Super HZ4000 (trade name), and TOSOH TSKgel Super HZ 2000 (trade name) is used.

Carrier: Tetrahydrofuran

Measurement temperature: 40° C.

Carrier flow rate: 1.0 mL/min

Specimen concentration: 0.1% by mass

Detector: Refractive index (RI) detector

In a case in which a decrease in the interface resistance and the maintenance of the decreased interface resistance when used in an all-solid state secondary battery are taken into account, the content of the binder in the solid electrolyte-containing sheet is preferably 0.01% by mass or more, more preferably 0.1% by mass or more, and still more preferably 1% by mass or more in 100% by mass of the solid components. From the viewpoint of the battery characteristics, the upper limit is preferably 20% by mass or less, more preferably 10% by mass or less, and still more preferably 5% by mass or less.

In the present invention, the mass ratio of the total mass (total amount) of the inorganic solid electrolyte and the inorganic compound (C) having a film in the present invention on a surface to the mass of the binder[(the mass of the inorganic solid electrolyte plus the mass of the inorganic compound (C) having a film in the present invention on a surface plus the mass of an active material)/the mass of the binder] is preferably in a range of 1,000 to 1. Furthermore, this ratio is more preferably 500 to 2 and more preferably 100 to 10.

In the present invention, the binder is preferably a polymer particle that is insoluble in the dispersion medium (F) from the viewpoint of the dispersion stability of the solid electrolyte composition. Here, “the polymer particle is a particle that is insoluble in the dispersion medium (F)” means that, even in a case in which the polymer particles are added to a dispersion medium (F) (30° C.) and left to stand for 24 hours, the average particle diameter thereof is 5 nm or more, preferably 10 nm or more, and more preferably 30 nm or more.

(Active Material (E))

The solid electrolyte-containing sheet of the embodiment of the present invention may also contain an active material (E) capable of inserting and discharging an ion of a metal element belonging to Group I or II of the periodic table. Hereinafter, the active material (E) will also be simply referred to as the active material.

As the active material, a positive electrode active material and a negative electrode active material are exemplified, and a transition metal oxide that is a positive electrode active material and lithium titanate or graphite that is a negative electrode active material are preferred.

—Positive Electrode Active Material—

A positive electrode active material that the solid electrolyte-containing sheet of the embodiment of the present invention may contain is preferably a positive electrode active material capable of reversibly intercalating and deintercalating lithium ions. The above-described material is not particularly limited as long as the material has the above-described characteristics and may be transition metal oxides, organic substances, elements capable of being complexed with Li such as sulfur, complexes of sulfur and metal, or the like.

Among these, as the positive electrode active material, transition metal oxides are preferably used, and transition metal oxides having a transition metal element M^{a} (one or more elements selected from Co, Ni, Fe, Mn, Cu, and V) are more preferred. In addition, an element M^{b} (an element of Group I (Ia) of the metal periodic table other than lithium, an element of Group II (IIa), or an element such as Al, Ga, In, Ge, Sn, Pb, Sb, Bi, Si, P, or B) may be mixed into this transition metal oxide. The amount of the element mixed is preferably 0 to 30 mol % of the amount (100 mol %) of the transition metal element M^{a}. The positive electrode active material is more preferably synthesized by mixing the element into the transition metal oxide so that the molar ratio of Li/M^{a} reaches 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), lithium-containing transition metal silicate compounds (ME), and the like. In the present invention, the transition metal oxides having a bedded salt-type structure (MA) are preferred.

Specific examples of the transition metal oxides having a bedded salt-type structure (MA) include LiCoO₂ (lithium cobalt oxide [LCO]), LiNiO₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compounds (MC) include olivine-type iron phosphate salts such as LiFePO₄ (lithium iron phosphate [LFP]) and Li₃Fe₂(PO₄)₃, iron pyrophosphates such as LiFeP₂O₇, and cobalt phosphates such as LiCoPO₄, and monoclinic nasicon-type vanadium phosphate salt such as Li₃V₂(PO₄)₃ (lithium vanadium phosphate).

Examples of the lithium-containing transition metal halogenated phosphoric acid compounds (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, Li₂CoSiO₄, and the like.

In the present invention, the transition metal compounds having the lithium-containing transition metal phosphoric acid compounds (MC) are preferred, olivine-type iron phosphate salts are more preferred, and LFP is still more preferred.

The shape of the positive electrode active material is not particularly limited, but is preferably a particle shape. The volume-average particle diameter (circle-equivalent average particle diameter) of positive electrode active material particles is not particularly limited. For example, the volume-average particle diameter can be set to 0.1 to 50 μm. In order to provide a predetermined particle diameter to the positive electrode active material, an ordinary crusher or classifier may be used. Positive electrode active materials obtained using a firing method may be used after being washed with water, an acidic aqueous solution, an alkaline aqueous solution, or an organic solvent. The volume-average particle diameter (circle-equivalent average particle diameter) of positive electrode active material particles can be measured using a laser diffraction/scattering-type particle size distribution measurement instrument LA-920 (trade name, manufactured by Horiba Ltd.).

The positive electrode active material may be used singly or two or more positive electrode active materials may be used in combination.

In the case of forming a positive electrode active material layer, the mass (mg) of the positive electrode active material per unit area (cm²) of the positive electrode active material layer (weight per unit area) is not particularly limited. The mass (mg) of the positive electrode active material per unit area (cm²) of the positive electrode active material layer (weight per unit area) can be appropriately determined depending on the set battery capacity.

The content of the positive electrode active material in the solid electrolyte-containing sheet is not particularly limited, but is preferably 10% to 95% by mass, more preferably 30% to 90% by mass, still more preferably 50% to 85% by mass, and particularly preferably 55% to 80% by mass with respect to a solid content of 100% by mass.

—Negative Electrode Active Material—

A negative electrode active material that the solid electrolyte-containing sheet of the embodiment of the present invention may contain is preferably a negative electrode active material capable of reversibly intercalating and deintercalating lithium ions. The above-described material is not particularly limited as long as the material has the above-described characteristics, and examples thereof include carbonaceous materials, metal oxides such as tin oxide, silicon oxide, metal complex oxides, a lithium single body, lithium alloys such as lithium aluminum alloys, metals capable of forming alloys with lithium such as Sn, Si, Al, and In and the like. Among these, carbonaceous materials or metal complex oxides are preferably used in terms of reliability. In addition, the metal complex oxides are preferably capable of absorbing and deintercalating lithium. The materials are not particularly limited, but preferably contain titanium and/or lithium as constituent components from the viewpoint of high-current density charging and discharging characteristics.

The carbonaceous material that is used as the negative electrode active material is a material substantially consisting of carbon. Examples thereof include petroleum pitch, carbon black such as acetylene black (AB), graphite (natural graphite, artificial graphite such as highly oriented pyrolytic graphite), and carbonaceous material obtained by firing a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, glassy carbon fibers, and active carbon fibers, mesophase microspheres, graphite whisker, flat graphite, and the like.

The metal oxides and the metal complex oxides being applied as the negative electrode active material are particularly preferably amorphous oxides, and furthermore, chalcogenides which are reaction products between a metal element and an element belonging to Group XVI of the periodic table are also preferably used. The amorphous oxides mentioned herein refer to oxides having a broad scattering band having a peak of a 20 value in a range of 20° to 40° in an X-ray diffraction method in which CuKα rays are used and may have crystalline diffraction lines.

In a compound group consisting of the amorphous oxides and the chalcogenides, amorphous oxides of semimetal elements and chalcogenides are more preferred, and elements belonging to Groups XIII (IIIB) to XV (VB) of the periodic table, oxides consisting of one element or a combination of two or more elements of Al, Ga, Si, Sn, Ge, Pb, Sb, and Bi, and chalcogenides are particularly preferred. Specific examples of preferred amorphous oxides and chalcogenides include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Bi₂O₄, SnSiO₃, GeS, SnS, SnS₂, PbS, PbS₂, Sb₂S₃, Sb₂S₅, and SnSiS₃. In addition, these amorphous oxides may be complex oxides with lithium oxide, for example, Li₂SnO₂.

The negative electrode active material preferably contains a titanium atom. More specifically, Li₄Ti₅O₁₂ (lithium titanium oxide [LTO]) is preferred since the volume fluctuation during the absorption and deintercalation of lithium ions is small, and thus the high-speed charging and discharging characteristics are excellent, and the deterioration of electrodes is suppressed, whereby it becomes possible to improve the service lives of lithium ion secondary batteries.

In the present invention, a Si-based negative electrode is also preferably applied. Generally, a Si negative electrode is capable of absorbing a larger number of Li ions than a carbon negative electrode (graphite, acetylene black, or the like). That is, the amount of Li ions absorbed per unit mass increases. Therefore, it is possible to increase the battery capacity. As a result, there is an advantage that the battery drying duration can be extended.

The shape of the negative electrode active material is not particularly limited, but is preferably a particle shape. The average particle diameter of the negative electrode active material is preferably 0.1 μm to 60 μm. In order to provide a predetermined particle diameter, an ordinary crusher or classifier is used. For example, a mortar, a ball mill, a sand mill, an oscillatory ball mill, a satellite ball mill, a planetary ball mill, a swirling airflow-type jet mill, a sieve, or the like is preferably used. During crushing, it is also possible to carry out wet-type crushing in which water or an organic solvent such as methanol is made to coexist as necessary. In order to provide a desired particle diameter, classification is preferably carried out. The classification method is not particularly limited, and it is possible to use a sieve, a wind power classifier, or the like depending on the necessity. Both of dry-type classification and wet-type classification can be carried out. The average particle diameter of negative electrode active material particles can be measured using the same method as the method for measuring the volume-average particle diameter of the positive electrode active material.

The chemical formulae of the compounds obtained using a firing method can be computed using an inductively coupled plasma (ICP) emission spectroscopic analysis method as a measurement method from the mass difference of powder before and after firing as a convenient method.

The negative electrode active material may be used singly or two or more negative electrode active materials may be used in combination.

In the case of forming a negative electrode active material layer, the mass (mg) of the negative electrode active material per unit area (cm²) in the negative electrode active material layer (weight per unit area) is not particularly limited. The mass (mg) of the positive electrode active material per unit area (cm²) of the positive electrode active material layer (weight per unit area) can be appropriately determined depending on the set battery capacity.

The content of the negative electrode active material in the solid electrolyte-containing sheet is not particularly limited, but is preferably 10% to 80% by mass and more preferably 20% to 80% by mass with respect to a solid content of 100% by mass.

The surfaces of the positive electrode active material and/or the negative electrode active material may be coated with a separate metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, lithium niobite-based compounds, and the like, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, B₂O₃, and the like.

In addition, a surface treatment may be carried out on the surfaces of electrodes including the positive electrode active material or the negative electrode active material using sulfur, phosphorous, or the like.

Furthermore, the particle surfaces of the positive electrode active material or the negative electrode active material may be treated with an active light ray or an active gas (plasma or the like) before or after the coating of the surfaces.

(Conductive Auxiliary Agent)

The solid electrolyte-containing sheet of the embodiment of the present invention also preferably contains a conductive auxiliary agent. The conductive auxiliary agent is not particularly limited, and conductive auxiliary agents that are known as ordinary conductive auxiliary agents can be used. The conductive auxiliary agent may be, for example, graphite such as natural graphite or artificial graphite, carbon black such as acetylene black, Ketjen black, or furnace black, irregular carbon such as needle cokes, a carbon fiber such as a vapor-grown carbon fiber or a carbon nanotube, or a carbonaceous material such as graphene or fullerene which are electron-conductive materials and also may be metal powder or a metal fiber of copper, nickel, or the like, and a conductive polymer such as polyaniline, polypyrrole, polythiophene, polyacetylene, or a polyphenylene derivative may also be used. In addition, these conductive auxiliary agents may be used singly or two or more conductive auxiliary agents may be used.

In the present invention, in the case of jointly using the negative electrode active material and the conductive auxiliary agent, a conductive auxiliary agent which does not cause the intercalation and deintercalation of Li during the charging and discharging of batteries and does not function as the negative electrode active material is used as the conductive auxiliary agent. Therefore, among conductive auxiliary agents, conductive auxiliary agents capable of functioning as a negative electrode active material in negative electrode active material layers during the charging and discharging of batteries are classified not as the conductive auxiliary agent but as the negative electrode active material. Whether or not a conductive auxiliary agent functions as a negative electrode active material during the charging and discharging of batteries cannot be unambiguously determined and is determined by the combination with a negative electrode active material.

The content of the conductive auxiliary agent is preferably 0% to 5% by mass and more preferably 0% to 3% by mass with respect to 100% by mass of the solid contents in the solid electrolyte-containing sheet.

(Dispersant)

The solid electrolyte-containing sheet of the embodiment of the present invention may also contain a dispersant. The addition of the dispersant enables the suppression of the agglomeration of the active material and the sulfide-based inorganic solid electrolyte even in a case in which the concentration of any of the active material and the sulfide-based inorganic solid electrolyte is great or a case in which the particle diameters are small and the surface area increases and the formation of a uniform active material layer and a uniform solid electrolyte layer. As the dispersant, a dispersant that is generally used for an all-solid state secondary battery can be appropriately selected and used. Generally, a compound intended for particle adsorption and steric repulsion and/or electrostatic repulsion is preferably used.

(Lithium Salt)

The solid electrolyte-containing sheet of the embodiment of the present invention may contain a lithium salt other than the salt of a metal belonging to Group I or II of the periodic table.

The lithium salt is not particularly limited, and, for example, lithium salts described in Paragraphs 0082 to 0085 of JP2015-088486A are preferred.

The content of the lithium salt is preferably 0 parts by mass or more and more preferably 5 parts by mass or more with respect to 100 parts by mass of the sulfide-based inorganic solid electrolyte. The upper limit is preferably 50 parts by mass or less and more preferably 20 parts by mass or less.

The solid electrolyte-containing sheet of the embodiment of the present invention can be preferably used in all-solid state secondary batteries and is modified in a variety of aspects depending on the uses. Examples of the solid electrolyte-containing sheet that is used in the all-solid state secondary battery include a sheet that is preferably used in a solid electrolyte layer (also referred to as a solid electrolyte sheet for an all-solid state secondary battery), a sheet that is preferably used in an electrode or a laminate of an electrode and a solid electrolyte layer (an electrode sheet for an all-solid state secondary battery), and the like. In the present invention, a variety of sheets described above will be collectively referred to as a sheet for an all-solid state secondary battery in some cases.

The sheet for an all-solid state secondary battery is a sheet having a solid electrolyte layer or an active material layer (electrode layer), and examples thereof include an aspect of a sheet having a solid electrolyte layer or an active material layer (electrode layer) on a base material and an aspect in which the base material is peeled off from the above-described aspect, that is, an aspect of a solid electrolyte layer material or an active material layer material (electrode layer material). Hereinafter, the sheet as the former aspect will be described in detail.

This sheet for an all-solid state secondary battery may further have other layers as long as the sheet has the base material and the solid electrolyte layer or the active material layer, but a sheet containing an active material is classified into an electrode sheet for an all-solid state secondary battery described below. Examples of other layers include a protective layer, a collector, a coating layer (a collector, a solid electrolyte layer, or an active material layer), and the like.

Examples of the solid electrolyte sheet for an all-solid state secondary battery include a sheet having a solid electrolyte layer and a protective layer on a base material in this order.

The base material is not particularly limited as long as the base material is capable of supporting the solid electrolyte layer, and examples thereof include sheet bodies (plate-like bodies) of materials, organic materials, inorganic materials, and the like described in the section of the collector described below. Examples of the organic materials include a variety of polymers and the like, and specific examples thereof include polyethylene terephthalate, polypropylene, polyethylene, cellulose, and the like. Examples of the inorganic materials include glass, ceramic, and the like.

The layer thickness of the solid electrolyte layer in the sheet for an all-solid state secondary battery is identical to the layer thickness of the solid electrolyte layer described in the section of an all-solid state secondary battery of the embodiment of the present invention.

This sheet is obtained by forming a film of the solid electrolyte composition for forming the solid electrolyte layer (by means of application and drying) on the base material (possibly, through other layers) and forming a solid electrolyte layer on the base material.

Here, the solid electrolyte composition of the embodiment of the present invention can be prepared using the above-described method.

An electrode sheet for an all-solid state secondary battery of the embodiment of the present invention (also simply referred to as “the electrode sheet”) is an electrode sheet that is a sheet for forming an active material layer in an all-solid state secondary battery and has an active material layer on a metal foil as a collector. This electrode sheet is generally a sheet having a collector and an active material layer, and an aspect of having a collector, an active material layer, and a solid electrolyte layer in this order and an aspect of having a collector, an active material layer, a solid electrolyte layer, and an active material layer in this order are also considered as the electrode sheet.

The layer thicknesses of the respective layers constituting the electrode sheet are identical to the layer thicknesses of individual layers described in the section of an all-solid state secondary battery of the embodiment of the present invention. In addition, the constitutions of the respective layers constituting the electrode sheet are identical to the constitutions of individual layers described in the section of an all-solid state secondary battery of the embodiment of the present invention.

The electrode sheet is obtained by forming a film of the solid electrolyte composition of the embodiment of the present invention (by means of application and drying) on the metal foil and forming an active material layer on the metal foil.

<Solid Electrolyte Composition>

A solid electrolyte composition contains the inorganic solid electrolyte (A) having a conductivity of an ion of a metal belonging to Group I or II of the periodic table and the solid electrolyte (B) and contains the inorganic compound (C) having a film having a conductivity of an ion of a metal belonging to Group I or II of the periodic table on a surface and the dispersion medium (F). Regarding the solid components that the solid electrolyte composition of the embodiment of the present invention contains, the solid components that the solid electrolyte-containing sheet of the embodiment of the present invention contains and the contents thereof can be employed.

(Dispersion Medium (F))

The solid components that the solid electrolyte composition of the embodiment of the present invention contains a dispersion medium (F) that disperses the respective components described above. Specific examples of the dispersion medium (F) will be described below.

As an alcohol compound solvent, for example, methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

As an ether compound solvent, for example, alkylene glycol alkyl ethers (ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, propylene glycol dimethyl ether, dipropylene glycol monomethyl ether, tripropylene glycol monomethyl ether, diethylene glycol monobutyl ether, diethylene glycol dibutyl ether, and the like), dialkyl ethers (dimethyl ether, diethyl ether, diisopropyl ether, dibutyl ether, and the like), alkyl aryl ether (anisole), tetrahydrofuran, dioxane, t-butyl methyl ether, and cyclomethyl ether are exemplified.

As an amide compound solvent, for example, N,N-dimethylformamide, 1-methyl-2-pyrrolidone, 2-pyrrolidinone, 1,3-dimethyl-2-imidazolidinone, 2-pyrrolidinone, ε-caprolactam, formamide, N-methylformamide, acetamide, N-methylacetamide, N,N-dimethylacetamide, N-methylpropanamide, and hexamethylphosphoric triamide are exemplified.

As an amino compound solvent, for example, triethylamine, diisopropylethylamine, and tributylamine are exemplified.

As a ketone compound solvent, for example, acetone, methyl ethyl ketone, methyl isobutyl ketone, and cyclohexanone are exemplified.

As an aromatic compound solvent, for example, benzene, toluene, xylene, and mesitylene are exemplified.

As an aliphatic compound solvent, for example, hexane, heptane, cyclohexane, methylcyclohexane, octane, pentane, cyclopentane, and cyclooctane are exemplified.

As a nitrile compound solvent, for example, acetonitrile, propionitrile, and butyronitrile are exemplified.

The boiling point of the dispersion medium at a normal pressure (1 atmospheric pressure) is preferably 50° C. or higher and more preferably 70° C. or higher. The upper limit is preferably 250° C. or lower and more preferably 220° C. or lower. The dispersion medium may be used singly or two or more dispersion media may be used in combination.

—Preparation of Solid Electrolyte Composition—

The solid electrolyte composition of the embodiment of the present invention can be prepared by dispersing the inorganic solid electrolyte (A) and the inorganic compound (C) having a film in the present invention on a surface in the presence of the dispersion medium (F) to produce a slurry.

The slurry can be produced by mixing the inorganic solid electrolyte (A), the inorganic compound (C) having a film in the present invention on a surface, and the dispersion medium (F) using a variety of mixers. The mixing device is not particularly limited, and examples thereof include a ball mill, a beads mill, a planetary mixer, a blade mixer, a roll mill, a kneader, and a disc mill. The mixing conditions are not particularly limited; however, in the case of using a ball mill, the inorganic solid electrolyte and the dispersion medium are preferably mixed together at 150 to 700 rpm (rotations per minute) for one hour to 24 hours. In addition, the order of adding the respective components is not particularly limited as long as the effect of the present invention is exhibited.

In the case of preparing a solid electrolyte composition containing components such as the active material (E), the conductive auxiliary agent, and a particle dispersant, the components may be added and mixed at the same time as a dispersion step of the inorganic solid electrolyte (A) and the inorganic compound (C) having the film in the present invention on the surface or may be separately added and mixed.

<All-Solid State Secondary Battery>

An all-solid state secondary battery of the embodiment of the present invention has a positive electrode, a negative electrode facing the positive electrode, and a solid electrolyte layer between the positive electrode and the negative electrode. The positive electrode has a positive electrode active material layer on a positive electrode collector. The negative electrode has a negative electrode active material layer on a negative electrode collector.

In the all-solid state secondary battery of the embodiment of the present invention, at least one layer of the positive electrode active material layer, the solid electrolyte layer, or the negative electrode active material layer is the solid electrolyte-containing sheet of the embodiment of the present invention. At least one layer of the positive electrode active material layer, the solid electrolyte layer, or the negative electrode active material layer is formed using the solid electrolyte-containing sheet of the embodiment of the present invention, two layers are preferably formed using the solid electrolyte-containing sheet of the embodiment of the present invention, and three layers are more preferably formed using the solid electrolyte-containing sheet of the embodiment of the present invention.

The kinds and the content ratio of the components of the positive electrode active material layer, the solid electrolyte layer, and the negative electrode active material layer formed of the solid electrolyte composition of the embodiment of the present invention are preferably, basically, identical to those in the solid content of the solid electrolyte composition.

In addition, the positive electrode active material layer, the solid electrolyte layer, and the negative electrode active material layer may also contain the dispersion medium (F) to an extent to which the battery performance is not affected, and the content thereof is preferably 1 ppm or more and 10,000 ppm or less. Meanwhile, the content proportion of the dispersion medium (F) in the active material layer of the all-solid state secondary battery of the embodiment of the present invention can be measured with reference to a method described in the section of the solid electrolyte-containing sheet of the embodiment of the present invention described below.

Hereinafter, a preferred embodiment of the present invention will be described with reference to FIG. 1, but the present invention is not limited thereto.

—Positive Electrode Active Material Layer, Solid Electrolyte Layer, and Negative Electrode Active Material Layer—

In the all-solid state secondary battery 10, at least one layer of the positive electrode active material layer, the solid electrolyte layer, or the negative electrode active material layer is the solid electrolyte-containing sheet of the embodiment of the present invention.

In a case in which the positive electrode active material layer 4 and/or the negative electrode active material layer 2 are the solid electrolyte-containing sheet of the embodiment of the present invention which contains the active material, the positive electrode active material layer 4 and the negative electrode active material layer 2 respectively include a positive electrode active material or a negative electrode active material and further include the inorganic solid electrolyte (A) and the inorganic compound (C) having a film in the present invention on a surface.

The kinds of the respective components that the positive electrode active material layer 4, the solid electrolyte layer 3, and the negative electrode active material layer 2 contain may be identical to or different from each other.

—Collector (Metal Foil)—

The positive electrode collector 5 and the negative electrode collector 1 are preferably an electron conductor.

In the present invention, there are cases in which any or both of the positive electrode collector and the negative electrode collector will be simply referred to as the collector.

As a material forming the positive electrode collector, aluminum, an aluminum alloy, stainless steel, nickel, titanium, or the like, and furthermore, a material obtained by treating the surface of aluminum or stainless steel with carbon, nickel, titanium, or silver (a material forming a thin film) is preferred, and, among these, aluminum and an aluminum alloy are more preferred.

As a material forming the negative electrode collector, aluminum, copper, a copper alloy, stainless steel, nickel, titanium, or the like, and furthermore, a material obtained by treating the surface of aluminum, copper, a copper alloy, or stainless steel with carbon, nickel, titanium, or silver is preferred, and aluminum, copper, a copper alloy, or stainless steel is more preferred.

Regarding the shape of the collector, generally, collectors having a film sheet-like shape are used, but it is also possible to use net-shaped collectors, punched collectors, compacts of lath bodies, porous bodies, foaming bodies, or fiber groups, and the like.

The thickness of the collector is not particularly limited, but is preferably 1 to 500 μm. In addition, the surface of the collector is preferably provided with protrusions and recesses by means of a surface treatment.

In the present invention, a functional layer, member, or the like may be appropriately interposed or disposed between the respective layers of the negative electrode collector, the negative electrode active material layer, the solid electrolyte layer, the positive electrode active material layer, and the positive electrode collector or on the outside thereof. In addition, the respective layers may be composed of a single layer or multiple layers.

—Chassis—

It is possible to produce the basic structure of the all-solid state secondary battery by disposing the respective layers described above. Depending on the use, the basic structure may be directly used as an all-solid state secondary battery, but the basic structure may be used after being enclosed in an appropriate chassis in order to have a dry battery form. The chassis may be a metallic chassis or a resin (plastic) chassis. In a case in which a metallic chassis is used, examples thereof include an aluminum alloy chassis and a stainless-steel chassis. The metallic chassis is preferably classified into a positive electrode-side chassis and a negative electrode-side chassis and electrically connected to the positive electrode collector and the negative electrode collector respectively. The positive electrode-side chassis and the negative electrode-side chassis are preferably integrated by being joined together through a gasket for short circuit prevention.

<Manufacturing of Solid Electrolyte-Containing Sheet>

The solid electrolyte-containing sheet of the embodiment of the present invention is obtained by forming a film of the solid electrolyte composition containing the inorganic solid electrolyte (A) having a conductivity of an ion of a metal belonging to Group I or II of the periodic table and the solid electrolyte (B) and containing the inorganic compound (C) having a film having a conductivity of an ion of a metal belonging to Group I or II of the periodic table on a surface and the dispersion medium (F) (by means of application and drying) on a base material (possibly, through other layers) to form a solid electrolyte layer or an active material layer on the base material. It is also possible to produce a solid electrolyte-containing sheet consisting of only the solid electrolyte layer or the active material layer by peeling the base material after the formation of the solid electrolyte layer or the active material layer.

Additionally, regarding steps such as application, it is possible to use a method described in the following section of the manufacturing of an all-solid state secondary battery.

Meanwhile, the solid electrolyte-containing sheet of the embodiment of the present invention may also contain the dispersion medium (F) in the layer to an extent to which the battery performance is not affected, and a preferred content thereof is 1 ppm or more and 10,000 ppm or less.

Meanwhile, the content proportion of the dispersion medium (F) in the layer of the all-solid state secondary battery of the embodiment of the present invention can be measured using the following method.

A 20 mm×20 mm piece is punched out from the solid electrolyte-containing sheet and immersed in heavy tetrahydrofuran in a glass bottle. The obtained eluted substance is filtered using a syringe filter, thereby carrying out a quantitative operation by ¹H-NMR. The correlativity between the ¹H-NMR peak area and the amount of the solvent is obtained by producing a calibration curve.

<All-Solid State Secondary Battery and Manufacturing of Electrode Sheet for All-Solid State Secondary Battery>

The all-solid state secondary battery and the electrode sheet for an all-solid state secondary battery can be manufactured using an ordinary method. Specifically, the all-solid state secondary battery and the electrode sheet for an all-solid state secondary battery can be manufactured by forming the respective layers described above using the solid electrolyte composition of the embodiment of the present invention or the like. The manufacturing method will be described below in detail.

The all-solid state secondary battery of the embodiment of the present invention can be manufactured using a method including a step of applying the solid electrolyte composition containing the inorganic solid electrolyte (A) having a conductivity of an ion of a metal belonging to Group I or II of the periodic table and the solid electrolyte (B) and containing the inorganic compound (C) having a film having a conductivity of an ion of a metal belonging to Group I or II of the periodic table on a surface and the dispersion medium (F) (by means of application and drying) onto a base material (for example, a metal foil that serves as the collector) and forming a coated film.

For example, a solid electrolyte composition containing a positive electrode active material is applied as a material for a positive electrode (a composition for a positive electrode) onto a metal foil which is a positive electrode collector so as to form a positive electrode active material layer, thereby producing a positive electrode sheet for an all-solid state secondary battery. Next, a solid electrolyte composition for forming a solid electrolyte layer is applied onto the positive electrode active material layer so as to form a solid electrolyte layer. Furthermore, a solid electrolyte composition containing a negative electrode active material is applied as a material for a negative electrode (a composition for a negative electrode) onto the solid electrolyte layer so as to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can be produced by enclosing the all-solid state secondary battery in a chassis as necessary.

In addition, it is also possible to manufacture an all-solid state secondary battery by carrying out the methods for forming the respective layers in a reverse order so as to form a negative electrode active material layer, a solid electrolyte layer, and a positive electrode active material layer on a negative electrode collector and overlaying a positive electrode collector thereon.

As another method, the following method can be exemplified. That is, a positive electrode sheet for an all-solid state secondary battery is produced as described above. In addition, a solid electrolyte composition containing a negative electrode active material is applied as a material for a negative electrode (a composition for a negative electrode) onto a metal foil which is a negative electrode collector so as to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer so that the solid electrolyte layer and the active material layer come into contact with each other. An all-solid state secondary battery can be manufactured as described above.

As still another method, the following method can be exemplified. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, a solid electrolyte composition is applied onto a base material, thereby producing a solid electrolyte-containing sheet consisting of a solid electrolyte layer. Furthermore, the positive electrode sheet for an all-solid state secondary battery and the negative electrode sheet for an all-solid state secondary battery are laminated together so as to sandwich the solid electrolyte layer that has been peeled off from the base material. An all-solid state secondary battery can be manufactured as described above.

An all-solid state secondary battery can be manufactured by combining the above-described forming methods. For example, a positive electrode sheet for an all-solid state secondary battery, a negative electrode sheet for an all-solid state secondary battery, and a solid electrolyte-containing sheet consisting of a solid electrolyte layer are produced respectively. Next, a solid electrolyte layer peeled off from a base material is laminated on the negative electrode sheet for an all-solid state secondary battery and is then attached to the positive electrode sheet for an all-solid state secondary battery, whereby an all-solid state secondary battery can be manufactured. In this method, it is also possible to laminate the solid electrolyte layer on the positive electrode sheet for an all-solid state secondary battery and attach the solid electrolyte layer to the negative electrode sheet for an all-solid state secondary battery.

—Formation of Individual Layers (Film Formation)—

The method for applying the solid electrolyte composition is not particularly limited and can be appropriately selected. Examples thereof include coating (preferably wet-type coating), spray coating, spin coating, dip coating, slit coating, stripe coating, and bar coating.

At this time, the solid electrolyte composition may be dried after being applied or may be dried after being applied to multiple layers. The drying temperature is not particularly limited. The lower limit is preferably 30° C. or higher, more preferably 60° C. or higher, and still more preferably 80° C. or higher. The upper limit is preferably 300° C. or lower, more preferably 250° C. or lower, and still more preferably 200° C. or lower. In a case in which the composition is heated in the above-described temperature range, it is possible to remove the dispersion medium (F) and form the layers in a solid state. In addition, the temperature is not excessively increased, and the respective members of the all-solid state secondary battery are not impaired, and thus the drying temperature is preferably in the above-described range. In such a case, in the all-solid state secondary battery, excellent general performance is exhibited, and a favorable bonding property can be obtained.

After the production of the applied solid electrolyte composition or the all-solid state secondary battery, the respective layers or the all-solid state secondary battery is preferably pressurized. In addition, the respective layers are also preferably pressurized in a state of being laminated together. Examples of the pressurization method include a hydraulic cylinder pressing machine and the like. The welding pressure is not particularly limited, but is, generally, preferably in a range of 50 to 1,500 MPa.

In addition, the applied solid electrolyte composition may be heated at the same time as pressurization. The heating temperature is not particularly limited, but is generally in a range of 30° C. to 300° C. The respective layers or the all-solid state secondary battery can also be pressed at a temperature higher than the glass transition temperature of the sulfide-based inorganic solid electrolyte.

The pressurization may be carried out in a state in which the applied solvent or the dispersion medium has been dried in advance or in a state in which the solvent or the dispersion medium remains.

Meanwhile, the respective compositions may be applied at the same time, and the application, the drying, and the pressing may be carried out simultaneously and/or sequentially. The respective compositions may be applied to separate base materials and then laminated by means of transfer.

The atmosphere during the pressurization is not particularly limited and may be any of in the atmosphere, under the dried air (the dew point: −20° C. or lower), in an inert gas (for example, in an argon gas, in a helium gas, or in a nitrogen gas), and the like.

The pressing time may be a short time (for example, within several hours) at a high pressure or a long time (one day or longer) under the application of an intermediate pressure. In the case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or different on portions under pressure such as a sheet surface.

The pressing pressure can be changed depending on the area or film thickness of the portion under pressure. In addition, it is also possible to change the pressure to vary stepwise for the same portion.

The pressing surface may be flat or roughened.

—Initialization—

The all-solid state secondary battery manufactured as described above is preferably initialized after manufacturing or before use. The initialization is not particularly limited, and it is possible to initialize the all-solid state secondary battery by, for example, carrying out initial charging and discharging in a state in which the pressing pressure is increased and then releasing the pressure up to a pressure at which the all-solid state secondary battery is generally used.

[Uses of All-Solid State Secondary Battery]

The all-solid state secondary battery of the embodiment of the present invention can be applied to a variety of uses. Application aspects are not particularly limited, and, in the case of being mounted in electronic devices, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, portable tape recorders, radios, backup power supplies, memory cards, and the like. Additionally, examples of consumer uses include automobiles (electric vehicles and the like), electric vehicles, motors, lighting equipment, toys, game devices, road conditioners, watches, strobes, cameras, medical devices (pacemakers, hearing aids, shoulder massage devices, and the like), and the like. Furthermore, the all-solid state secondary battery can be used for a variety of military uses and universe uses. In addition, the all-solid state secondary battery can also be combined with solar batteries.

An all-solid state secondary battery refers to a secondary battery in which a positive electrode, a negative electrode, and an electrolyte are all formed of solid. In other words, the all-solid state secondary battery is differentiated from an electrolytic solution-type secondary battery in which a carbonate-based solvent is used as an electrolyte. Among these, the present invention is assumed to be an inorganic all-solid state secondary battery. All-solid state secondary batteries are classified into organic (polymer) all-solid state secondary batteries in which a polymer compound such as polyethylene oxide is used as an electrolyte and inorganic all-solid state secondary batteries in which the Li—P—S-based glass, LLT, LLZ, or the like is used. Meanwhile, the application of an organic compound to an inorganic all-solid state secondary battery is not inhibited, and an organic compound can also be applied as a binder or an additive of a positive electrode active material, a negative electrode active material, and an inorganic solid electrolyte.

An inorganic solid electrolyte is differentiated from an electrolyte in which the above-described polymer compound is used as an ion-conductive medium (polymer electrolyte), and an inorganic compound serves as an ion-conductive medium. Specific examples thereof include the Li—P—S-based glass, LLT, and LLZ. An inorganic solid electrolyte does not emit a positive ion (Li ion) and exhibits an ion transportation function. In contrast, there is a case in which a material serving as an ion supply source which is added to an electrolytic solution or a solid electrolyte layer and emits a positive ion (Li ion) is referred to as an electrolyte. In the case of being differentiated from an electrolyte as the ion transportation material, the material is referred to as an “electrolyte salt” or a “supporting electrolyte”. Examples of the electrolyte salt include LiTFSI.

In the present invention, a “composition” refers to a mixture obtained by uniformly mixing two or more components. Here, the composition may partially include agglomeration or uneven distribution as long as the composition substantially maintains uniformity and exhibits a desired effect.

### EXAMPLES

Hereinafter, the present invention will be described in more detail on the basis of examples. Meanwhile, the present invention is not interpreted to be limited thereto. “Parts” and “%” that represent compositions in the following examples are mass-based unless particularly otherwise described.

<Synthesis of Sulfide-Based Inorganic Solid Electrolyte>

As a sulfide-based inorganic solid electrolyte, Li—P—S-based glass was synthesized with reference to non-patent documents of T. Ohtomo, A. Hayashi, M. Tatsumisago, Y. Tsuchida, S. HamGa, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a glove box under an argon atmosphere (dew point: −70° C.), lithium sulfide (Li₂S, manufactured by Aldrich-Sigma, Co. LLC. purity: >99.98%) (2.42 g) and diphosphorus pentasulfide (P₂S₅, manufactured by Aldrich-Sigma, Co. LLC., purity: >99%) (3.90 g) were respectively weighed and injected into a mortar. The molar ratio between Li₂S and P₂S₅ was set to 75:25. The components were mixed on an agate mortar using an agate muddler for five minutes.

Zirconia beads having a diameter of 5 mm (66 g) were injected into a 45 mL zirconia container (manufactured by Fritsch Japan Co., Ltd.), the full amount of the mixture was injected thereinto, and the container was sealed in an argon atmosphere. The container was set in a planetary ball mill P-7 (trade name) manufactured by Fritsch Japan Co., Ltd., mechanical milling was carried out at 25° C. and a rotation speed of 510 rpm for 20 hours, thereby obtaining yellow powder (6.20 g) of a sulfide-based inorganic solid electrolyte (Li—P—S-based glass, LPS). The volume-average particle diameter was 15 μm.

### Example 1

<Preparation of Coated Inorganic Compound>

LPS (0.2 g) was dissolved in N-methylformamide (NMF) (1.8 g) at room temperature, thereby obtaining an NMF solution in which LPS was dissolved. Al₂O₃ (volume-average particle diameter: 2 μm, manufactured by Aldrich-Sigma, Co. LLC.) (1.85 g) was added to the above-described solution (1.5 g), stirred at room temperature for 10 minutes, and dried at a reduced pressure and 180° C. for three hours, thereby obtaining Al₂O₃ coated with LPS.

<Preparation of Solid Electrolyte Composition>

One hundred and eighty zirconia beads having a diameter of 5 mm were injected into a 45 mL zirconia container (manufactured by Fritsch Japan Co., Ltd.), and the LPS synthesized above (the inorganic solid electrolyte (A) in Table 1) (3.88 g), Al₂O₃ (the inorganic compound (C) in Table 1) coated with LPS (the solid electrolyte (B) in Table 1) obtained above (0.97 g), KYNAR FLEX 2800-00 (trade name, manufactured by Arkema K. K., PVdF-HFP) (0.15 g), and heptane (11.7 g) were injected thereinto. After that, the container was set in a planetary ball mill P-7 (trade name) manufactured by Fritsch Japan Co., Ltd., and the components were continuously mixed at a temperature of 25° C. and a rotation speed of 300 rpm for two hours, thereby obtaining a solid electrolyte composition.

(Production Example of Solid Electrolyte Sheet for All-Solid State Secondary Battery)

Each of the solid electrolyte compositions obtained above was applied onto a 20 μm-thick aluminum foil using an applicator (trade name: SA-201 Baker type applicator, manufactured by Tester Sangyo Co., Ltd.), heated at 80° C. for two hours, and dried, thereby obtaining each solid electrolyte sheet for an all-solid state secondary battery. The thickness of the solid electrolyte layer was 100 μm.

### Example 2

A solid electrolyte sheet for an all-solid state secondary battery was produced using the same method as in Example 1 except for the fact that the Al₂O₃ was changed to Li₇La₃Zr2O₁₂ (volume-average particle diameter: 3 μm, LLZ: manufactured by Toshima Manufacturing Co., Ltd.). The thickness of the solid electrolyte layer was 100 μm.

### Example 3

<Preparation of Coated Inorganic Compound>

Polyethylene oxide (PEO, mass-average molecular weight: 100,000, manufactured by Wako Pure Chemical Industries, Ltd.) (0.14 g) and lithium bis(trifluoromethanesulfonyl)imide (LiTFSI, manufactured by Wako Pure Chemical Industries, Ltd.) (0.06 g) were dissolved in acetonitrile (1.8 g) at room temperature. LLZ (manufactured by Toshima Manufacturing Co., Ltd.) (1.85 g) was added to the above-described solution (1.5 g), stirred at room temperature for 10 minutes, and dried at a reduced pressure and 100° C. for three hours, thereby obtaining LLZ coated with a film including PEO and LiTFSI.

A solid electrolyte sheet for an all-solid state secondary battery was produced using the same method as in Example 1 except for the fact that the Al₂O₃ coated with LPS was changed to LLZ coated with the film including PEO and LiTFSI. The thickness of the solid electrolyte layer was 100 μm.

### Example 4

<Surface Treatment of LLZ by Introduction of Amino Group>

LLZ powder (20 g) was irradiated with nitrogen plasma as low-temperature atmospheric-pressure plasma for 20 minutes in an atmospheric-pressure powder plasma device ASS-400 (trade name, manufactured by Sakigake-Semiconductor Co., Ltd.), thereby obtaining LLZ having an amino group. Irradiation conditions will be described below.

<Irradiation Conditions>

Irradiation temperature: Room temperature (25° C.)

Distance between LLZ powder and nozzle of atmospheric-pressure powder plasma device: 100 mm

Flow rate of nitrogen gas: 0.5 L/min

Output: 250 W

Rotation speed: 4 rpm

Pressure: 100 kPa

A solid electrolyte sheet for an all-solid state secondary battery was produced using the same method as in Example 1 except for the fact that the Al₂O₃ was changed to LLZ having an amino group. The thickness of the solid electrolyte layer was 100 μm.

### Example 5

<Surface Treatment of LLZ by Introduction of Carboxy Group>

LLZ powder (20 g) was irradiated with carbon dioxide plasma as low-temperature atmospheric-pressure plasma for 20 minutes in an atmospheric-pressure powder plasma device ASS-400 (trade name, manufactured by Sakigake-Semiconductor Co., Ltd.), thereby obtaining LLZ having a carboxy group. Irradiation conditions will be described below.

<Irradiation Conditions>

Irradiation temperature: Room temperature (25° C.)

Distance between LLZ powder and nozzle of atmospheric-pressure powder plasma device: 100 mm

Flow rate of carbon dioxide gas: 0.5 L/min

Output: 250 W

Rotation speed: 4 rpm

Pressure: 100 kPa

A solid electrolyte sheet for an all-solid state secondary battery was produced using the same method as in Example 1 except for the fact that the Al₂O₃ was changed to LLZ having a carboxy group. The thickness of the solid electrolyte layer was 100 μm.

### Example 6

A solid electrolyte sheet for an all-solid state secondary battery was produced using the same method as in Example 5 except for the fact that the KYNAR FLEX 2800-00 was changed to a polyurethane resin obtained using the following synthesis method. The thickness of the solid electrolyte layer was 100 μm.

<Synthesis of Binder (Polyurethane Resin)>

In order to synthesize a polyurethane resin, first, terminated diol dodecyl polymethacrylate was synthesized.

Specifically, methyl ethyl ketone (20 mL) was prepared in a 500 mL three-neck flask and heated to 75° C. under a nitrogen stream. Meanwhile, dodecyl methacrylate (manufactured by Wako Pure Chemical Industries, Ltd.) (70 g) and methyl ethyl ketone (110 g) were prepared in a 500 mL measuring cylinder and stirred for 10 minutes. Thioglycerol (manufactured by Wako Pure Chemical Industries, Ltd.) (2.9 g) as a chain transfer agent and a radical polymerization initiator V-601 (trade name, manufactured by Wako Pure Chemical Industries, Ltd.) (3.2 g) were added thereto and, furthermore, stirred for 10 minutes. The obtained monomer solution was added dropwise to the 500 mL three-neck flask for two hours, and radical polymerization was initiated. Furthermore, after the end of the dropwise addition, heating and stirring were continued at 75° C. for six hours. The obtained polymerized liquid was depressurized and condensed, methyl ethyl ketone was distilled away, and then a solid substance was dissolved in heptane, thereby obtaining a 25% by mass heptane solution of terminated diol-modified dodecyl polymethacrylate (292 g). The mass-average molecular weight of the obtained polymer was 3,200.

Subsequently, a polyurea colloid particle MM-3 was synthesized.

Specifically, the 25% by mass heptane solution of terminated diol-modified dodecyl polymethacrylate (260 g) was added to a 1 L three-neck flask and diluted with heptane (110 g). Isophorone diisocyanate (manufactured by Wako Pure Chemical Industries, Ltd.) (11.1 g) and NEOSTAN U-600 (trade name, Nitto Kasei Co., Ltd.) (0.1 g) were added thereto and heated and stirred at 75° C. for five hours. After that, a liquid obtained by diluting isophorone diamine (amine compound) (0.4 g) with heptane (125 g) was added dropwise thereto for one hour. The polymer solution changed to a solution having a transparent to light yellow fluorescent color in 10 minutes after the initiation of the dropwise addition. From this change, the formation of a polyurea colloid was confirmed. The reaction liquid was cooled to room temperature, thereby obtaining a 15% by mass heptane solution of a polyurea colloid particle MM-3 (506 g).

The mass-average molecular weight of a polyurea in the polyurea colloid particle MM-3 was 9,600.

Next, a polyurethane resin was synthesized using the polyurea colloid particle MM-3.

Specifically, m-phenylene isocyanate (manufactured by Tokyo Chemical Industry Co., Ltd.) (3.2 g) and polyethylene glycol (mass-average molecular weight: 400, manufactured by Aldrich-Sigma, Co. LLC.) (8.0 g) were added to a 50 mL sample bottle. The 15% by mass heptane solution of the polyurea colloid particle MM-3 (32.0 g) was added thereto and dispersed using a homogenizer for 30 minutes while heated at 50° C. During this time, the liquid mixture turned into fine particles and a slurry having a light orange color. The obtained slurry was injected into a 200 mL three-neck flask that had been heated to a temperature of 80° C. in advance, NEOSTAN U-600 (trade name, Nitto Kasei Co., Ltd.) (0.1 g) was added thereto, and the components were heated and stirred at a temperature of 80° C. for three hours at a rotation speed of 400 rpm. The slurry turned into a white emulsion form. From this fact, it was assumed that a binder particle consisting of a polyurethane resin was formed. The white emulsion-form slurry was cooled, thereby obtaining a heptane dispersion liquid of a binder particle B-7 consisting of the polyurethane resin. The concentration of the solid content was 40.3%, the SP value was 11.1, and the mass-average molecular weight was 98,000. Meanwhile, the concentration of the solid content of the obtained binder was measured as described below.

<Method for Measuring Concentration of Solid Content>

The concentration of the solid content of the dispersion liquid of the binder particle was measured on the basis of the following method.

Approximately 1.5 g of the dispersion liquid of the binder particle was weighed in an aluminum cup (7 cmϕ), and the weighed value was scanned to the three decimal places. Subsequently, the dispersion liquid of the binder particle was dried by being heated at 90° C. for two hours and at 140° C. for two hours in a nitrogen atmosphere. The mass of the obtained residue in the aluminum cup was measured, and the concentration of the solid content was computed using the following equation. The mass was measured five times, and the average of three measured masses excluding the maximum value and the minimum value was employed.

Concentration of solid content (%)=amount of residue in aluminum cup (g)/dispersion liquid of binder particle (g)

### Example 7

A solid electrolyte sheet for an all-solid state secondary battery was produced using the same method as in Example 2 except for the fact that the content ratio was changed as shown in Table 1, and the binder was not used. The thickness of the solid electrolyte layer was 100 μm.

### Example 8

A solid electrolyte sheet for an all-solid state secondary battery was produced using the same method as in Example 1 except for the fact that the Al₂O₃ was changed to SiO₂ (volume-average particle diameter: 0.2 μm, manufactured by Aldrich-Sigma, Co. LLC.).

The thickness of the solid electrolyte layer was 100

### Comparative Example 1

A solid electrolyte sheet for an all-solid state secondary battery was produced using the same method as in Example 1 except for the fact that the Al₂O₃ coated with LPS was not used. The thickness of the solid electrolyte layer was 100 μm.

### Comparative Example 2

A solid electrolyte sheet for an all-solid state secondary battery was produced using the same method as in Example 1 except for the fact that Al₂O₃ was not coated with LPS. The thickness of the solid electrolyte layer was 100 μm.

### Comparative Example 3

<Preparation of Coated Inorganic Compound>

A phosphoric anhydride (manufactured by Aldrich-Sigma, Co. LLC.) (30.0 g), lithium acetate (manufactured by Aldrich-Sigma, Co. LLC.) (2.0 g), and LLZ (volume-average particle diameter: 3 μm, manufactured by Toshima Manufacturing Co., Ltd.) (3 g) were stirred at room temperature for one hour, an excess solution was removed by suction filtration, and the components were dried by being heated at a temperature of 150° C. for six hours at a reduced pressure of 200 Pa, thereby obtaining LLZ coated with Li₃PO₄.

A solid electrolyte sheet for an all-solid state secondary battery was produced using the same method as in Example 1 except for the fact that mixing was carried out for 15 minutes using LLZ coated with Li₃PO₄ at a rotation speed set to 150 rpm. The thickness of the solid electrolyte layer was 100 μm.

### Comparative Example 4

A solid electrolyte sheet for an all-solid state secondary battery was produced using the same method as in Example 7 except for the fact that LPS was changed to LLZ, and LLZ coated with LPS was changed to LPS.

### Comparative Example 5

A solid electrolyte sheet for an all-solid state secondary battery was produced using the same method as in Example 1 except for the fact that LPS was changed to LLZ, and Al₂O₃ coated with LPS was changed to LPS.

On the produced solid electrolyte sheets for an all-solid state secondary battery, the following tests were carried out, and the results are shown in Table 1. Meanwhile, in Table 1, solid electrolyte sheets for an all-solid state secondary battery Nos. are indicated by “Sheet No.”

<Evaluation of Initial Short Circuits>

A disc-shaped piece having a diameter of 14.5 mm was cut out from the solid electrolyte sheets for an all-solid state secondary battery obtained above, an aluminum foil cut out in a disc shape having a diameter of 14.5 mm was brought into contact therewith, the resistance was measured, and then the piece was pressed at 600 MPa. After the pressing, the resistance was measured, and the presence or absence of a short circuit was confirmed. The presence or absence of a short circuit in 10 test samples produced from one solid electrolyte sheet for an all-solid state secondary battery was confirmed as described above, the average short circuit percentage of 10 test samples was evaluated using the following evaluation standards, and the initial short circuits were evaluated. Evaluation standards of “3” or higher are pass. The results are shown in Table 1.

—Evaluation Standards—

5: The short circuit percentage is 0% or more and less than 20%.

4: The short circuit percentage is 20% or more and less than 40%.

3: The short circuit percentage is 50% or more and less than 60%.

2: The short circuit percentage is 60% or more and less than 80%.

1: The short circuit percentage is 80% or more.

A short circuit “being present” means that the ratio of the resistance before pressing to the resistance after pressing is greater than 10.

<Measurement of Ion Conductivity>

A disc-shaped piece having a diameter of 14.5 mm was cut out from the solid electrolyte sheets for an all-solid state secondary battery obtained above and pressed at 600 MPa. This solid electrolyte sheet for an all-solid state secondary battery 17 was put into a 2032-type coin case 16 illustrated in FIG. 2. Specifically, an aluminum foil cut out in a disc shape having a diameter of 15 mm (not illustrated in FIG. 2) was brought into contact with the solid electrolyte layer, a spacer and a washer were combined into the coin case, and the aluminum foil was put into the 2032-type stainless steel coin case 16. The 2032-type coin case 16 was swaged, thereby producing a jig for ion conductivity measurement 18.

The ion conductivity was measured using the above-obtained jig for ion conductivity measurement. Specifically, alternating current impedance was measured in a constant-temperature tank (30° C.) using a 1255B FREQUENCY RESPONSE ANALYZER (trade name) manufactured by Solartron Analytical. Inc. at a voltage magnitude of 5 mV and wavelengths of 1 MHz to 1 Hz. Therefore, the resistance of a specimen in the layer thickness direction was obtained, and the resistance was obtained by means of calculation using Expression (A). Evaluation standards of “3” or higher are pass. The results are shown in Table 1.

Ion conductivity (mS/cm)=1,000×specimen layer thickness (cm)/(resistance (Ω)×specimen area (cm²)) Expression (A)

In Expression (A), the specimen layer thickness refers to the thickness of the solid electrolyte layer in the sold electrolyte sheet for an all-solid state secondary battery that had been pressed at 600 MPa and was to be put into the 2032-type coin case 16.

—Evaluation Standards—

5: 0.4 mS/cm or more

4: 0.3 mS/cm or more and less than 0.4 mS/cm

3: 0.2 mS/cm or more and less than 0.3 mS/cm

2: 0.1 mS/cm or more and less than 0.2 mS/cm

1: Less than 0.1 mS/cm

<Measurement of Aging Short Circuits>

The measurement of aging short circuits will be described with reference to FIGS. 2 and 3.

A lithium foil 23 cut out to 14 mmϕ was put into the stainless steel 2032-type coin case 16 in which a spacer and a washer were combined together, and an indium foil 22 cut out to 14.5 mmϕ was overlaid on the lithium foil 23. A disc-shaped piece having a diameter of 15 mm was cut out from the solid electrolyte sheet for an all-solid state secondary battery obtained above, and the solid electrolyte sheet for an all-solid state secondary battery was overlaid so that the solid electrolyte layer came into contact with the indium foil 22. After overlaid, the solid electrolyte sheet for an all-solid state secondary battery was pressurized and transferred at 30 MPa, then, the aluminum foil of the solid electrolyte sheet for an all-solid state secondary battery was peeled off, and a solid electrolyte layer 21 was overlaid. An indium foil 20 cut out to 14.5 mmϕ was overlaid on the solid electrolyte layer 21. A lithium foil 19 cut out to 14 mmϕ was overlaid thereon, an electrode sheet for an all-solid state secondary battery 24 (17) was formed, and then the 2032-type coin case 16 was swaged, thereby producing a cell for aging short circuit evaluation 18.

The cell for aging short circuit evaluation 18 manufactured as described above has a structure illustrated in FIG. 2, and the electrode sheet for an all-solid state secondary battery 24 (17) has a layer constitution illustrated in FIG. 3.

The cell for aging short circuit evaluation obtained above was measured using a charge and discharge evaluation device TOSCAT-3000 (trade name) manufactured by Toyo System Corporation. Charging was carried out at a current density of 1 mA/cm² for two hours, and discharging was carried out at a current density of 1 mA/cm² for two hours. Charging and discharging was repeated under the above-described conditions, and the minimum number of cycles in which a short circuit behavior could be confirmed was evaluated using the following standards. Evaluation standards of “4” or higher are pass. The results are shown in Table 1.

—Evaluation Standards—

8: 200 cycles or more

7: 170 cycles or more and less than 200 cycles

6: 140 cycles or more and less than 170 cycles

5: 110 cycles or more and less than 140 cycles

4: 80 cycles or more and less than 110 cycles

3: 50 cycles or more and less than 80 cycles

2: 20 cycles or more and less than 50 cycles

1: Less than 20 cycles

<Evaluation of Bonding Property>

A disc-shaped piece having a diameter of 15 mm was cut out from the solid electrolyte sheet for an all-solid state secondary battery, the cut-out sheet was peeled off from an aluminum foil (collector), and a surface of the solid electrolyte layer in contact with the aluminum foil was observed (observation region: 500 μm×500 μm) using an optical microscope for inspection (ECLIPSE Ci (trade name), manufactured by Nikon Corporation), thereby evaluating the presence and absence of chips, breakages, or cracks in the solid electrolyte layer and the presence and absence of the peeling of the solid electrolyte layer (the presence and absence of the attachment of the solid electrolyte layer to the aluminum foil) using the following evaluation standards. Evaluation standards of “2” or higher are pass. The results are shown in Table 2.

—Evaluation Standards—

5: Defects (chips, breakages, cracks, or peels) were not observed.

4: The area of a defect portion occupied more than 0% and 20% or less of the entire area that was the observation subject.

3: The area of a defect portion occupied more than 20% and 40% or less of the entire area that was the observation subject.

2: The area of a defect portion occupied more than 40% and 70% or less of the entire area that was the observation subject.

1: The area of a defect portion occupied more than 70% of the entire area that was the observation subject.

TABLE 1

| | | Content | | | Content | Surface | Func- | | Content | Initial | Ion | Aging | | |
|---|---|---|---|---|---|---|---|---|---|---|---|---|---|---|
| Sheet | | (% by | | | (% by | treat- | tional | | (% by | short | conduc- | short | Bonding | |
| No. | (A) | mass) | (B) | (C) | mass) | ment | group | (D) | mass) | circuit | tivity | circuit | property | Note |
| 101 | LPS | 77.6 | LPS | Al₂O₃ | 19.4 | No | None | PVdF- | 3 | 4 | 3 | 5 | 2 | Example 1 |
| | | | | | | | | HFP | | | | | | |
| 102 | LPS | 77.6 | LPS | LLZ | 19.4 | No | None | PVdF- | 3 | 4 | 4 | 5 | 2 | Example 2 |
| | | | | | | | | HFP | | | | | | |
| 103 | LPS | 77.6 | PEO | LLZ | 19.4 | No | None | PVdF- | 3 | 4 | 3 | 4 | 2 | Example 3 |
| | | | | | | | | HFP | | | | | | |
| 104 | LPS | 77.6 | LPS | LLZ | 19.4 | Yes | Amino | PVdF- | 3 | 4 | 4 | 6 | 3 | Example 4 |
| | | | | | | | group | HFP | | | | | | |
| 105 | LPS | 77.6 | LPS | LLZ | 19.4 | Yes | Carboxy | PVdF- | 3 | 5 | 4 | 7 | 3 | Example 5 |
| | | | | | | | group | HFP | | | | | | |
| 106 | LPS | 77.6 | LPS | LLZ | 19.4 | Yes | Carboxy | Polyure- | 3 | 5 | 5 | 8 | 5 | Example 6 |
| | | | | | | | group | thane | | | | | | |
| | | | | | | | | resin | | | | | | |
| 107 | LPS | 80 | LPS | LLZ | 20 | No | None | None | 0 | 3 | 4 | 4 | 1 | Example 7 |
| 108 | LPS | 77.6 | LPS | SiO₂ | 19.4 | No | None | PVdF- | 3 | 4 | 3 | 5 | 2 | Example 8 |
| | | | | | | | | HFP | | | | | | |
| c-1 | LPS | 100 | None | None | 0 | No | None | None | 0 | 1 | 3 | 2 | 1 | Comparative |
| | | | | | | | | | | | | | | Example 1 |
| c-2 | LPS | 80 | None | Al₂O₃ | 20 | No | None | None | 0 | 3 | 1 | 2 | 1 | Comparative |
| | | | | | | | | | | | | | | Example 2 |
| c-3 | None | 0 | Li₃PO₄ | LLZ | 100 | No | None | None | 0 | 3 | 1 | 1 | 1 | Comparative |
| | | | | | | | | | | | | | | Example 3 |
| c-4 | LLZ | 80 | None | LPS | 20 | No | None | None | 0 | 3 | 1 | 1 | 1 | Comparative |
| | | | | | | | | | | | | | | Example 4 |
| c-5 | LLZ | 77.6 | None | LPS | 19.4 | No | None | PVdF- | 3 | 3 | 1 | 1 | 2 | Comparative |
| | | | | | | | | HFP | | | | | | Example 5 |

<Notes of table>
(A): Inorganic solid electrolyte (A)
(B): Solid electrolyte (B)
(C): Inorganic compound (C)
(D): Binder (D)
LPS: The sulfide-based inorganic solid electrolyte synthesized above
Mixture of PEO: Polyethylene oxide (mass-average molecular weight: 100,000, manufactured by Wako Pure Chemical Industries, Ltd.) and lithium bis(trifluoromethanesulfonyl)imide (manufactured by Wako Pure Chemical Industries, Ltd.) in a mass ratio of 70/30
LLZ: Li₇La₃Zr₂O₁₂ (manufactured by Toshima Manufacturing Co., Ltd.)
PVdF-HFP: KYNAR FLEX 2800-00 (manufactured by Arkema K. K.)

Meanwhile, the second left contents of the contents for sheet Nos. 101 to 110 and c-3 indicate the contents of the coated inorganic compound (C).

From Table 1, it is found that the solid electrolyte-containing sheet of the embodiment of the present invention is capable of sufficiently suppressing initial short circuits and aging short circuits in all-solid state secondary batteries.

In contrast, the solid electrolyte-containing sheet of Comparative Example 1 did not contain the coated inorganic compound. This solid electrolyte-containing sheet of Comparative Example 1 failed in the evaluations of the initial short circuits and the aging short circuits.

The solid electrolyte-containing sheet of Comparative Example 3 did not contain the inorganic solid electrolyte (A). This solid electrolyte-containing sheet of Comparative Example 3 failed in the evaluations of the initial short circuits and the aging short circuits.

In the solid electrolyte-containing sheets of Comparative Examples 2, 4, and 5, the inorganic compound (C) did not have a film containing the solid electrolyte (B) on a surface. These solid electrolyte-containing sheets of Comparative Examples 2, 4, and 5 failed in the evaluations of the initial short circuits and the aging short circuits.

Particularly, in the solid electrolyte-containing sheets of Comparative Examples 4 and 5, hard particles and soft particles are mixed together, and thus the particles do not sufficiently follow the expansion and contraction of the active material caused by the charging and discharging of the all-solid state secondary batteries, and it is considered that peeling is likely to occur at the interfaces between the particles and the resistance increases.

The same test as described above was carried out on solid electrolyte-containing sheets containing an active material that were produced in the same manner as the solid electrolyte sheet for an all-solid state secondary battery not containing an active material, and it was confirmed that the occurrence of initial short circuits and aging short circuits can be effectively suppressed.

The present invention has been described together with the embodiment; however, unless particularly specified, the present inventors do not intend to limit the present invention to any detailed portion of the description and consider that the present invention is supposed to be broadly interpreted within the concept and scope of the present invention described in the claims.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
16: 2032-type coin case
17: Solid electrolyte sheet for all-solid state secondary battery or electrode sheet for all-solid state secondary battery
18: Jig for ion conductivity measurement or cell for aging short circuit evaluation
19, 23: lithium foil
20, 22: indium foil
21: solid electrolyte layer
24: electrode sheet for all-solid state secondary battery

What is claimed is:

1. A solid electrolyte-containing sheet comprising:
an inorganic solid electrolyte (A) having a conductivity of an ion of a metal belonging to Group I or II of the periodic table; and
an inorganic compound (C) having a film on a surface,
wherein the film contains a solid electrolyte (B) and has a conductivity of an ion of a metal belonging to Group I or II of the periodic table, and
wherein the inorganic solid electrolyte (A) and the solid electrolyte (B) are compounds represented by Formula (1),
Lₐ₁M_{b1}P_{c1}S_{d1}Aₑ₁ Formula (1)
in the formula, L represents an element selected from Li, Na, and K, M represents an element selected from B, Zn, Sn, Si, Cu, Ga, Sb, Al, and Ge, A represents an element selected from I, Br, Cl, and F, al to el represent compositional ratios of the respective elements, and a1:b1:c1:d1:e1 satisfies 1 to 12:0 to 5:1:2 to 12:0 to 10.

2. The solid electrolyte-containing sheet according to claim 1,
wherein the inorganic compound (C) is a compound represented by any of Formulae (c-1) to (c-13),
LiₓₐLa_{ya}TiO₃ Formula (c-1)
in the formula, xa and ya represent compositional ratios, xa satisfies 0.3≤xa≤0.7, and ya satisfies 0.3≤ya≤0.7,
Li_{xb}La_{yb}Zr_{zb}M^{bb}_{mb}O_{nb} Formula (c-2)
in the formula, M^{bb} represents Al, Mg, Ca, Sr, V, Nb, Ta, Ti, Ge, In, Sn, or a combination of two or more elements selected from Al, Mg, Ca, Sr, V, Nb, Ta, Ti, Ge, In, and Sn, xb, yb, zb, mb, and nb represent compositional ratios, xb satisfies 5≤x≤xb≤10, yb satisfies 1≤yb≤4, zb satisfies 1≤zb≤4, mb satisfies 0≤mb≤2, and nb satisfies 5≤nb≤20.
Li_{3.5}Zn_{0.25}GeO₄ Formula (c-3)
LiTi₂P₃O₁₂ Formula (c-4)
Li_{1+xh+yh}(Al, Ga),ₓₕ(Ti, Ge)₂₋ₓₕSi_{yh}P_{3-yh}O₁₂ Formula (c-5)
in the formula, xh satisfies 0≤xh≤1, and yh satisfies 0≤yh≤1.
Li₃PO₄ Formula (c-6)
LiPON Formula (c-7)
LiPOD¹ Formula (c-8)
in the formula, D¹ represents Ti, V, Cr, Mn, Fe, Co, Ni, Cu, Zr, Nb, Mo, Ru, Ag, Ta, W, Pt, Au, or a combination of two or more elements selected from Ti, V, Cr, Mn, Fe, Co, Ni, Cu, Zr, Nb, Mo, Ru, Ag, Ta, W, Pt, and Au,
LiA¹ON Formula (c-9)
in the formula, A¹ represents Si, B, Ge, Al, C, Ga, or a combination of two or more elements selected from Si, B, Ge, Al, C, and Ga,
Li_{xc}B_{yc}M^{cc}_{zc}O_{nc} Formula (c-10)
in the formula, M^{cc} represents C, S, Al, Si, Ga, Ge, In, Sn, or a combination of two or more elements selected from C, S, Al, Si, Ga, Ge, In, and Sn, xc, yc, zc, and nc represent compositional ratios, xc satisfies 0≤xc≤5, yc satisfies 0<yc≤1, zc satisfies 0<zc≤1, and nc satisfies 0<nc≤6.
Li₍₃₋₂ₓₑ₎M^{ee}ₓₑD^{ee}O Formula (c-11)
in the formula, xe represents a numeric value of 0 or more and 0.1 or less, and M^{ee} represents a divalent metal atom, D^{ee} represents a halogen atom or a combination of two or more halogen atoms,
Li_{xf}Si_{yf}O_{zf} Formula (c-12)
in the formula, xf, yf, and zf represent compositional ratios, xf satisfies 1≤xf≤5, yf satisfies 0<yf≤3, and zf satisfies 1<zf≤10.
Li_{xg}S_{yg}O_{zg} Formula (c-13)
in the formula, xg, yg, and zg represent compositional ratios, xg satisfies 1≤xg≤3, yg satisfies 0<yg≤2, and zg satisfies 1≤zg≤10.

3. The solid electrolyte-containing sheet according to claim 1, wherein the inorganic compound (C) has at least one functional group of functional groups belonging to the following group of functional groups (I),
<group of functional groups (I)>
a carboxy group, a sulfo group, a phosphoric acid group, a phosphonic acid group, a hydroxy group, a sulfanyl group, an isocyanate group, an oxetanyl group, an epoxy group, a dicarboxylic anhydride group, a carboxylic halide group, a silyl group, and an amino group.

4. The solid electrolyte-containing sheet according to claim 1,
wherein the inorganic compound (C) has at least one functional group of functional groups belonging to the following group of functional groups (II),
<group of functional groups (II)>
a carboxy group, a sulfo group, a phosphoric acid group, a phosphonic acid group, a hydroxy group, an epoxy group, and an amino group.

5. The solid electrolyte-containing sheet according to claim 1,
wherein the inorganic compound (C) is surface-treated.

6. The solid electrolyte-containing sheet according to claim 1, further comprising:
a binder (D).

7. The solid electrolyte-containing sheet according to claim 6,
wherein the binder (D) is an acrylic resin and/or a polyurethane resin.

8. The solid electrolyte-containing sheet according to claim 1, further comprising:
an active material (E).

9. A solid electrolyte composition comprising:
an inorganic solid electrolyte (A) having a conductivity of an ion of a metal belonging to Group I or II of the periodic table;
an inorganic compound (C) having a film on a surface; and
a dispersion medium (F),
wherein the film contains a solid electrolyte (B) and has a conductivity of an ion of a metal belonging to Group I or II of the periodic table, and
wherein the inorganic solid electrolyte (A) and the solid electrolyte (B) are compounds represented by Formula (I),
Lₐ₁M_{b1}P_{c1}S_{d1}Aₑ₁ Formula (1)
in the formula, L represents an element selected from Li, Na, and K, M represents an element selected from B, Zn, Sn, Si, Cu, Ga, Sb, Al, and Ge, A represents an element selected from I, Br, Cl, and F, al to el represent compositional ratios of the respective elements, and a1:b:1:c1:d1:e1 satisfies 1 to 12:0 to 5:1:2 to 12:0 to 10.

10. The solid electrolyte composition according to claim 9,
wherein the inorganic compound (C) has at least one functional group of functional groups belonging to the following group of functional groups (I),
<group of functional groups (I)>
a carboxy group, a sulfo group, a phosphoric acid group, a phosphonic acid group, a hydroxy group, a sulfanyl group, an isocyanate group, an oxetanyl group, an epoxy group, a dicarboxylic anhydride group, a carboxylic halide group, a silyl group, and an amino group.

11. The solid electrolyte composition according to claim 9, further comprising:
a binder (D).

12. An all-solid state secondary battery comprising:
a positive electrode active material layer;
a negative electrode active material layer; and
a solid electrolyte layer,
wherein at least any of the positive electrode active material layer, the negative electrode active material layer, or the solid electrolyte layer is the solid electrolyte-containing sheet according to claim 1.

13. A method for manufacturing the solid electrolyte-containing sheet according to claim 1, the method comprising:
a step of applying a solid electrolyte composition onto a base material; and
a step of drying the applied solid electrolyte composition,
wherein the solid electrolyte composition comprises:
an inorganic solid electrolyte (A) having a conductivity of an ion of a metal belonging to Group I or II of the periodic table;
an inorganic compound (C) having a film on a surface; and
a dispersion medium (F),
in which the film contains a solid electrolyte (B) and has a conductivity of an ion of a metal belonging to Group I or II of the periodic table, and
in which the inorganic solid electrolyte (A) and the solid electrolyte (B) are compounds represented by Formula (1),
Lₐ₁M_{b1}P_{c1}S_{d1}Aₑ₁ Formula (1)
in the formula, L represents an element selected from Li, Na, and K, M represents an element selected from B, Zn, Sn, Si, Cu, Ga, Sb, Al, and Ge, A represents an element selected from I, Br, Cl, and F, al to el represent compositional ratios of the respective elements, and a1:b1:c1:d1:e1 satisfies 1 to 12:0 to 5:1:2 to 12:0 to 10.

14. A method for manufacturing an all-solid state secondary battery, wherein an all-solid state secondary battery is manufactured through the manufacturing method according to claim 13.
